(19) United States
(12) Patent Application Publication
(10) Pub. No.: US 2004/0220819 A1
(43) Pub. Date: Nov. 4, 2004

(54) Automated web-based tool to manage legal agreements and projects

(75) Inventors: Uday Shetty, Fremont, CA (US); Daniel Powers, Sunnyvale, CA (US); Bruce Kerr, Mountain View, CA (US); Lyne Lamoureux, San Francisco, CA (US); Grace-Ann Wu, Sunnyvale, CA (US)

Correspondence Address: Philip J. McKay, Gunnison, McKay & Hodgson, L.L.P., 1900 Garden Road, Suite 220, Monterey, CA, 93940, US

(73) Assignee: Sun Microsystems, Inc.

(21) Appl. No.: 10/427,868

(22) Filed: Apr. 30, 2003

(51) Int. Cl. G06F 17/60

(52) U.S. Cl. 705/1

(57) ABSTRACT

An automated system for interfacing a user, such as a project engineer a legal representative of a legal department, and a customer in the generation of legal agreements within a project development process. In some embodiments, the automated system generates reports to assist in the management of legal agreements.

### BACKGROUND OF THE INVENTION

1. Field of the Invention

The present invention is directed to the field of automated systems, and more particularly, to automated systems for integrating the generation of legal agreements into a project development process.

2. Description of Related Art

In highly competitive and rapidly advancing industries, such as the semiconductor and software development industries, it is important to bring a new product to market as soon as possible in order to achieve a strong market share, if even for a short period of time. Tied to this fast paced market approach is the need to provide adequate legal safeguards to protect both the production and intellectual property aspects of the product.

Project development groups are typically responsible for the project evaluation, design and implementation of a product. There are often several engineers working on different aspects of a product, and sometimes several products for the same customer. A legal department, typically separate from the project development groups, is typically responsible for legal oversight.

When project development groups were small it was relatively easy to keep track of individual project groups, the engineers assigned to the projects, and the customers involved with the projects. In short, resource management was relatively easy to assess due to the small number of people involved in a project. Obtaining a legal agreement for a project meant having to locate and involve someone from the legal department. Often coordinating a legal agreement that was acceptable to the project development group, the legal department, and a client was often time consuming, and, typically, avoided if possible.

As project development groups began to grow larger, it became difficult to effectively track and manage the product development group resources. Obtaining a legal agreement for a project was still time consuming, and was still typically avoided if possible. If legal agreements were developed, they were often individually developed without regard to any other projects that may have been ongoing with a customer resulting in multiple agreements for one customer and redundancy of efforts.

Consequently, even though a product may have been successfully brought to market, problems often began to arise later with respect to contractual production obligations, ownership of the intellectual property associated with the product, and/or loss of intellectual property rights. Gains made in bringing a product to market quickly, and avoiding legal review, were then frequently diminished by not adequately protecting the product at the outset of the project development with sufficient legal agreements and legal review.

### SUMMARY OF THE INVENTION

Broadly viewed, the present invention includes an automated system for interfacing a user, such as a project engineer, a legal representative of a legal department, and a customer in the generation of legal agreements during project development. In one embodiment of the invention, a user inputs legal agreement related data into an internal database on an internal network and initiates the generation of a legal agreement. The legal agreement is automatically posted to the internal network for review by the legal department. Upon approval of the legal agreement by the legal department, the legal agreement is automatically posted to an external database on an external network where the customer can review the legal agreement without access to the internal network and can accept or not accept the legal agreement. The acceptance or non-acceptance of the legal agreement by the customer is automatically logged in the external database and the customer and user are automatically notified of the acceptance or non-acceptance of the legal agreement. The internal database is then updated with data from the external database.

Further, in one embodiment, the present invention permits the user to initiate termination of a legal agreement with automatic notification of the legal department to review the proposed termination. In one embodiment, the present invention also permits the user to generate lists and reports to assist in the management of project development group resources and planning. Also, in one embodiment, the present invention permits separate Statements of Work (SOWs) for a single customer to operate under a single Engagement Agreement (EA), rather than having multiple, individual legal agreements for each project, thus avoiding duplication of efforts.

According to one embodiment, a Statement of Work (SOW) tool system includes: an SOW tool program; a first computer terminal communicatively coupled to the SOW tool program; a second computer terminal communicatively coupled to the SOW tool program; an internal SOW tool database communicatively coupled to the SOW tool program; an external SOW tool database communicatively coupled to the SOW tool program; and a third computer terminal communicatively coupled to the external SOW tool database. The SOW tool program, the first computer terminal, the second computer terminal, and the internal SOW tool database are part of an internal network. The external SOW tool database and the third computer terminal are part of an external network.

In another embodiment, a method for generating a legal agreement includes: providing an internal network; communicatively coupling a first party to the internal network; communicatively coupling a second party to the internal network; providing a program for generating a legal agreement, the program being accessible on the internal network; inputting legal agreement data into the program by the first party; the program generating a legal agreement; the program posting the legal agreement to the internal network for viewing and action by the second party, wherein the second party accesses the legal agreement and inputs an approval or a denial of the legal agreement to the program thereby creating an approved or denied legal agreement; providing an external network separate from the internal network; the program posting the approved legal agreement to the external network for viewing and action by a third party; and communicatively coupling the third party to the external network for viewing the approved legal agreement, wherein the third party accesses the approved legal agreement and inputs an acceptance or a non-acceptance of the approved legal agreement thereby creating an accepted or a non-accepted legal agreement.

In a next embodiment, a method for generating a legal agreement includes: providing an internal network; providing an SOW tool program for generating a legal agreement on the internal network; providing an internal database on the internal network, wherein the internal database is coupled to the SOW tool program, the SOW tool program storing data related to the legal agreement in the internal database; communicatively coupling a first party to the internal network; communicatively coupling a second party to the internal network; inputting legal agreement data into the SOW tool program by the first party; the SOW tool program generating a legal agreement; the SOW tool program posting the legal agreement to the internal network for viewing and action by the second party, wherein the second party accesses the legal agreement and inputs an approval or a denial of the legal agreement to the SOW tool program thereby creating an approved or denied legal agreement; providing an external network separate from the internal network; providing an external database on the external network, wherein the external database is accessible on the external network; the SOW tool program posting the approved legal agreement to the external network for viewing and action by a third party; communicatively coupling the third party to the external network for viewing the approved legal document, wherein the third party accesses the approved legal agreement and inputs an acceptance or a non-acceptance of the approved legal agreement to the external database thereby creating an accepted or a non-accepted legal agreement; automatically logging the acceptance or the non-acceptance of the approved legal agreement on the external database thereby creating logged data; and updating the internal database with at least a portion of the logged data.

In some embodiments, the program stores a status indicator associated with the legal agreement on the internal database that indicates the status of the legal agreement.

In a further embodiment, a computer system includes: a processor; and a memory coupled to the processor having stored therein computer readable instructions for a method for generating a legal agreement, wherein upon execution of the computer readable instructions on the processor, the method includes: receiving input of legal agreement data from a first party communicatively coupled to an internal network; generating a legal agreement; posting the legal agreement to an internal database on the internal network for viewing and action by a second party communicatively coupled to the internal network, wherein the second party accesses the legal agreement on the internal database and inputs an approval or a denial of the legal agreement thereby creating an approved or denied legal agreement; receiving input of the approval or the denial of the legal agreement; posting the approved legal agreement to an external database on an external network for viewing and action by a third party communicatively coupled to the external network, wherein the third party accesses the approved legal agreement and inputs an acceptance or a non-acceptance of the approved legal agreement to the external database thereby creating an accepted or a non-accepted legal agreement; receiving input of the acceptance or the non-acceptance of the approved legal agreement; automatically logging the acceptance or the non-acceptance of the approved legal agreement on the external database thereby creating logged data; and updating the internal database with at least a portion of the logged data.

In yet another embodiment, a computer program product for generating a legal agreement includes computer-readable instructions for a method including: receiving input of legal agreement data from a first party communicatively coupled to an internal network; generating a legal agreement; posting the legal agreement to an internal database on the internal network for viewing and action by a second party communicatively coupled to the internal network, wherein the second party accesses the legal agreement on the internal database and inputs an approval or a denial of the legal agreement thereby creating an approved or denied legal agreement; receiving input of the approval or the denial of the legal agreement; posting the approved legal agreement to an external database on an external network for viewing and action by a third party communicatively coupled to the external network, wherein the third party accesses the approved legal agreement and inputs an acceptance or a non-acceptance of the approved legal agreement to the external database thereby creating an accepted or a non-accepted legal agreement; receiving input of the acceptance or the non-acceptance of the approved legal agreement; automatically logging the acceptance or the non-acceptance of the approved legal agreement on the external database thereby creating logged data; and updating the internal database with at least a portion of the logged data.

It is to be understood that both the foregoing general description and following detailed description are intended only to exemplify and explain the invention as claimed.

### BRIEF DESCRIPTION OF THE DRAWINGS

The accompanying drawings, which are incorporated in, and constitute a part of this specification, illustrate embodiments of the invention, and together with the description, serve to explain the principles of the invention. In the drawings, the same reference numbers are used to denote similar components in the various embodiments.

In the drawings:

FIG. 1 illustrates a diagram of a Statement of Work (SOW) tool system 100 in accordance with one embodiment of the present invention;

FIG. 2 is a key to FIGS. 2A-2C illustrating a process flow diagram of a method implemented by the SOW tool system of FIG. 1 for generating a new Statement of Work (SOW) in accordance with one embodiment of the present invention;

FIG. 3 illustrates an example of a main menu GUI generated by the SOW tool system of FIG. 1 in accordance with one embodiment of the present invention;

FIGS. 4A-4F illustrate an example of a new SOW GUI generated by the SOW tool system of FIG. 1 in accordance with one embodiment of the present invention;

FIG. 5 illustrates an example of an e-mail generated by the SOW tool system of FIG. 1 in accordance with one embodiment of the present invention;

FIG. 6 illustrates an example of another e-mail generated by the SOW tool system of FIG. 1 in accordance with one embodiment of the present invention;

FIG. 7 illustrates a process flow diagram of a method implemented by the SOW tool system of FIG. 1 for editing a new SOW or EA in accordance with one embodiment of the invention;

FIG. 8 is a key to FIGS. 8A through 8C illustrating a process flow diagram of a method implemented by the SOW tool system of FIG. 1 for generating a new Engagement Agreement (EA) in accordance with one embodiment of the present invention;

FIG. 9 is a key to FIGS. 9A and 9B illustrating a process flow diagram of a method implemented by the SOW tool system of FIG. 1 for terminating an SOW in accordance with one embodiment of the present invention;

FIG. 10 illustrates an example of a Terminate GUI generated by the SOW tool system of FIG. 1 in accordance with one embodiment of the present invention;

FIG. 11 illustrates an example of a Terminate Reasons GUI generated by the SOW tool system of FIG. 1 in accordance with one embodiment of the present invention;

FIG. 12 illustrates an example of a Confirmation page generated by the SOW tool system of FIG. 1 in accordance with one embodiment of the present invention;

FIG. 13 illustrates an example of a list generated by the SOW tool system of FIG. 1 in response to selection of a List All SOW option in accordance with one embodiment of the present invention;

FIG. 14 illustrates an example of a list generated by the SOW tool system of FIG. 1 in response to selection of a Search SOW option and submission of search parameters to a Search SOW GUI in accordance with one embodiment of the present invention;

FIG. 15 illustrates an example of a list generated by the SOW tool system of FIG. 1 in response to selection of a List All EA option in accordance with one embodiment of the present invention;

FIG. 16 illustrates an example of a list generated by the SOW tool system of FIG. 1 in response to selection of a Search EA option and submission of search parameters to a Search EA GUI in accordance with one embodiment of the present invention;

FIG. 17 illustrates an example of a Reports GUI generated by the SOW tool system of FIG. 1 in response to selection of a Reports option in accordance with one embodiment of the present invention;

FIG. 18 illustrates an example of a No EA GUI generated by the SOW tool system of FIG. 1 in accordance with one embodiment of the present invention; and

FIG. 19 illustrates an example of a list generated by the SOW tool system of FIG. 1 in response to selection of an Edit SOW option in accordance with one embodiment of the present invention.

### DETAILED DESCRIPTION

The invention will now be described in reference to the accompanying drawings. The same reference numbers may be used throughout the drawings and the following description to refer to the same or like parts.

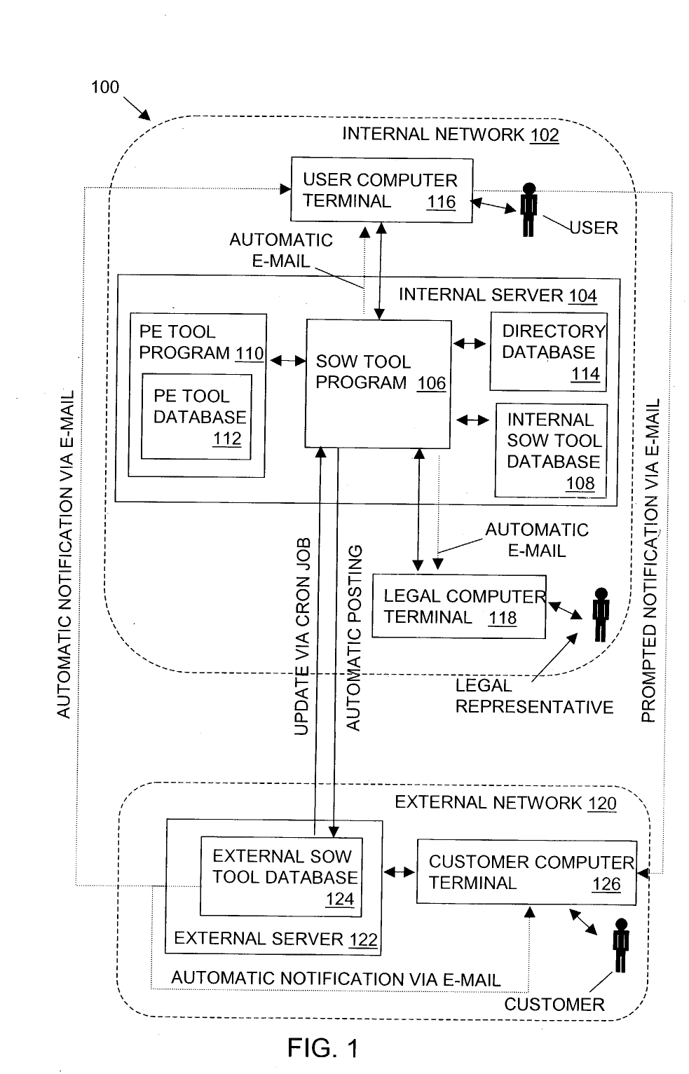

FIG. 1 illustrates a diagram of a Statement of Work (SOW) tool system 100 in accordance with one embodiment of the present invention. As illustrated in FIG. 1, in one embodiment, SOW tool system 100 includes an SOW tool program 106 communicatively coupled to an internal SOW tool database 108 within an internal network 102 and to an external SOW tool database 124 on an external network 120, such as the Internet. In the present embodiment, SOW tool system 100 further includes a user computer terminal 116, also called herein a first computer terminal, and a legal computer terminal 118, also called herein a second computer terminal, each communicatively coupled to SOW tool program 106 via internal network 102, and a customer computer terminal 126, also called herein a third computer terminal, communicatively coupled to external SOW tool database 124 via external server 122 and external network 120.

User computer terminal 116 and legal computer terminal 118 can be stand-alone computer systems communicatively coupled to internal network 102, or can be computer workstation terminals off of internal network 102. Customer-computer terminal 126 can also be a stand-alone computer system communicatively coupled to external network 120 or can be a computer workstation terminal off of another network communicatively coupled to external network 120.

Each of user computer terminal 116, legal computer terminal 118, and customer computer terminal 126 include at least a means for displaying information from SOW tool system 100, such as a display monitor, as well as a means of providing input to SOW tool system 100, such as a keyboard, mouse, input pad, or waveform port.

As illustrated in FIG. 1, in one embodiment, SOW tool system 100 also includes a Project Evaluation (PE) tool program 110, including a PE tool database 112, and a directory database 114, each communicatively coupled to SOW tool program 106 via internal network 102. In one embodiment, PE tool program 110 is a project evaluation tool used by project development groups to evaluate and develop different projects. In one embodiment, PE tool program 110 is a program that permits a business manager, engineer or other user to file a request with a project development group for assistance in a customer project. For example, a business manager would file a request by inputting information connected with the customer project into a business section of a graphical user interface presented by PE tool program 110.

In one embodiment, PE tool program 110 utilizes PE tool database 112 to store the input information as well as input information connected with different projects, such as customer information, project identifiers, project development descriptions, and evaluation parameters. In one embodiment, directory database 114 stores information related to a company and/or project development groups, such as employee names, employee addresses, employee project group identifiers, project group locations, employee e-mail addresses, and employee supervisor(s)/manager(s).

As illustrated in FIG. 1, SOW tool program 106, internal SOW tool database 108, PE tool program 110, including PE tool database 112, and directory database 114 are stored on an internal server 104 that is part of internal network 102. In one embodiment, internal server 104 includes a processor for implementing SOW tool program 106, including the methods 200, 700, 800, and 900 further described herein, and one or more memories in which SOW tool-program 106, internal SOW tool database 108, PE tool program 110, including PE tool database 112, and directory database 114 are stored. In other embodiments, SOW tool program 106 can be configured as a computer program product implemented by internal server 104.

In the present embodiment, external SOW tool database 124 is stored on external server 122 communicatively coupled to external network 120. In one embodiment, external server 122 includes a processor and a memory in which external SOW tool database 124 is stored. In one embodiment, internal network 102 is communicatively coupled with external server 122 via external network 120 by selectively establishing a link over external network 120. In other embodiments, a dedicated connection can communicatively couple internal network 102 to external server 122.

Although in the present embodiment, internal SOW tool database 108 is shown external to SOW tool program 106, in other embodiments, internal SOW tool database 108 can be internal to SOW tool program 106. Further, although SOW tool program 106, internal SOW tool database 108, PE tool program 110, PE tool database 112, and directory database 114 are shown in the present embodiment as residing on a single, internal server, e.g., internal server 104, in other embodiments, each or some of these parts can be stored on different internal servers and communicatively coupled within internal network 102.

In one embodiment, SOW tool system 100 permits a user, also called herein a first party, to automatically initiate the generation of legal agreements, such as Engagement Agreements (EAs) and Statements of Work (SOWs), for a customer and to automatically obtain review of the legal agreements by a legal representative, also called herein a second party, within the protected internal network 102 prior to review by the customer, also called herein a third party. When the user submits a legal agreement for review by the legal representative, SOW tool system 100 automatically posts the legal agreement on internal network 102 for review by the legal representative.

The legal representative is automatically notified via an e-mail generated by SOW tool program 106 of the location of the legal agreement on internal network 102 at which to review and approve or deny the legal agreement. When the legal representative (via legal computer terminal 118) approves the legal agreement, SOW tool system 100 automatically posts the legal agreement to external SOW tool database 124 on external network 120. SOW tool system 100 also automatically generates an e-mail to the user including a unique login ID, password, and the uniform resource listing (URL) address where the legal agreement can be viewed on external network 120, e.g., the address of the legal agreement in external SOW tool database 124 on external server 122.

In the present embodiment, the user is then responsible for generating an e-mail to the customer including the unique login ID, password, and URL address to the customer to allow the customer to review and accept, or not accept, the legal agreement. By placing the responsibility for forwarding the access information to the customer affords the user control of the notification process. As the user typically has the most direct involvement with the customer, the user can ensure the notification is sent to the correct contact point and with suitable timing considerations. For example, if a specified customer contact point is on vacation for two weeks, the user may prefer that the legal agreement notification be held or sent to another customer representative.

In other embodiments, the unique login ID, password, and URL address can be automatically sent to the customer. However, these other embodiments bypass the user's control over the notification of the customer.

The customer accesses the legal agreement on external SOW tool database 124 via customer computer terminal 126 using the URL address, unique login ID and password provided by the user. The customer reviews the legal agreement and then inputs acceptance or non-acceptance of the legal agreement via customer computer terminal 126. In some embodiments, the user only has a predetermined amount of time within which to accept or not accept the legal agreement.

When the customer submits the acceptance or non-acceptance of the legal agreement, the acceptance or non-acceptance is automatically logged on external SOW tool database 124 and an e-mail is automatically generated to the customer and the user with the acceptance or non-acceptance. In one embodiment, the data and time of the acceptance or non-acceptance are also logged on external SOW tool database 124. Thus, using SOW tool system 100, the customer can quickly interface in the legal agreement process of a project without having to access internal network 102.

In one embodiment, periodically, a cron job, e.g., a scheduled download, is performed between external server 122 and internal server 104 to update internal SOW tool database 108 with information from external SOW tool database 124, such as the logged acceptance or non-acceptance of a legal agreement.

In one embodiment, SOW tool system 100 stores and updates the status of the legal agreement as it progresses from initiation and legal review through to acceptance or non-acceptance by the customer, such as incomplete, legal processing, approved, denied, accepted, and not accepted. In some embodiments, SOW tool system 100 includes additional features that aid in the project development process, such as listings of legal agreements, search of legal agreements, saving drafts of legal agreements, editing of legal agreements, termination of legal agreements, and generation of reports summarizing legal agreement activity. In some embodiments, i.e., those in which termination of legal agreements generated using SOW tool system 100 is included, the status of the legal agreement can be updated to terminated.

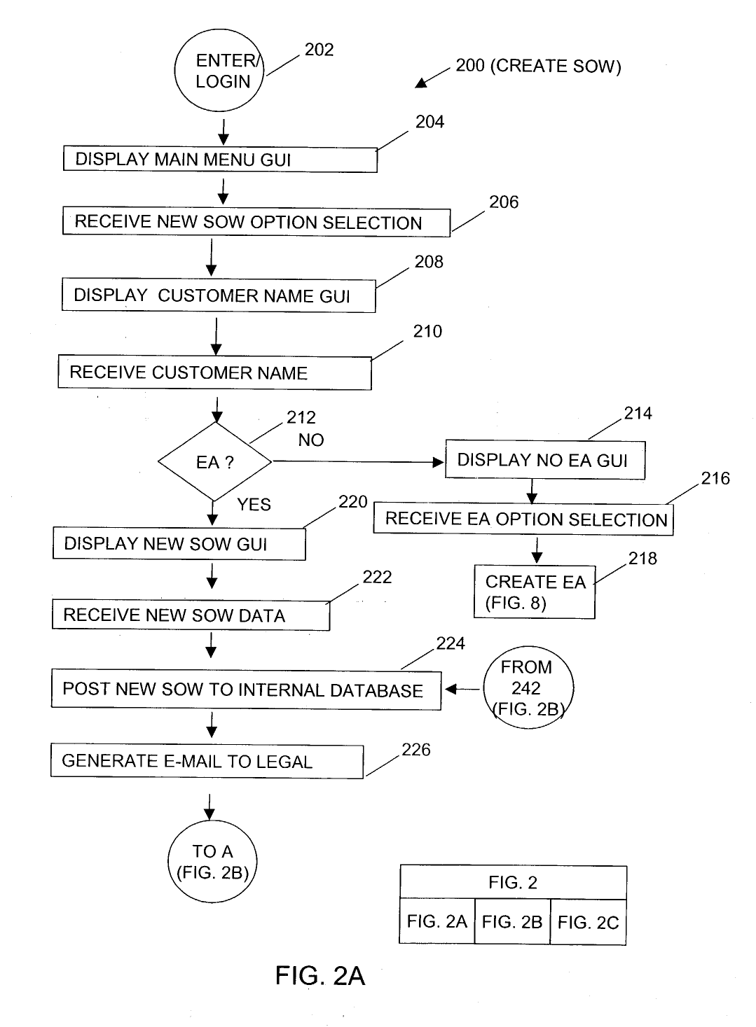

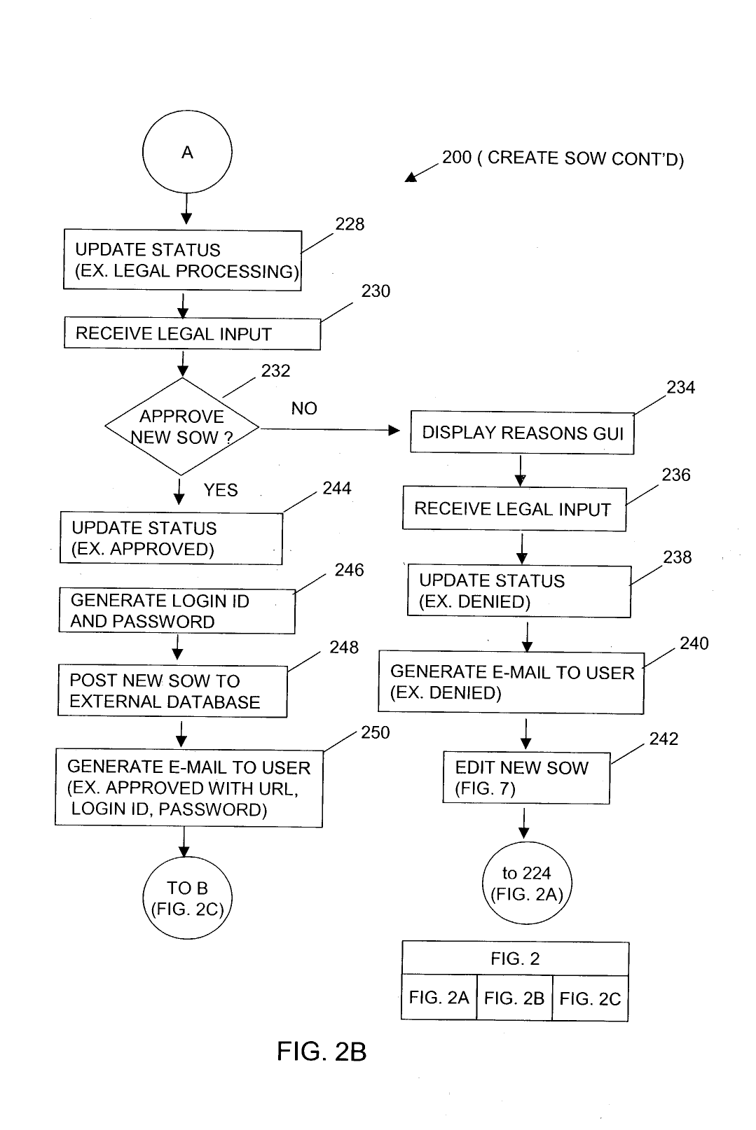

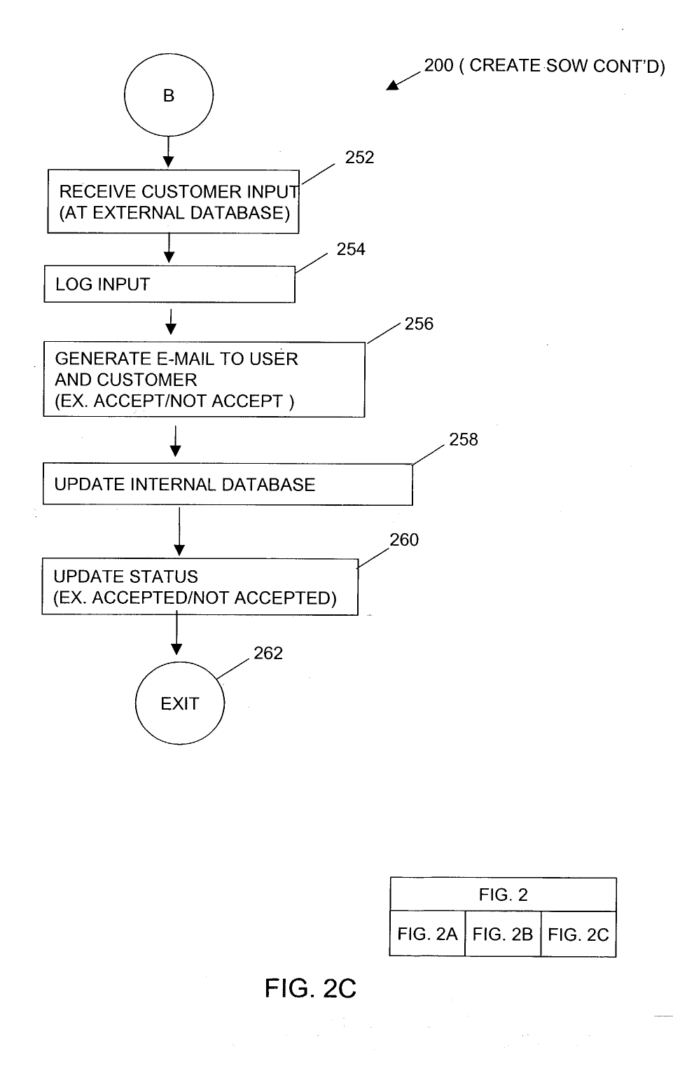

SOW tool system 100 is further described herein with reference to FIGS. 2-19. In FIGS. 2-19, one embodiment of the present invention is described in relation to a project development group and the generation of a Statement of Work (SOW) and an Engagement Agreement. (EA) supporting the SOW, e.g., the legal agreements. The following description is but one embodiment of the present invention, and is intended for illustrative purposes only. Consequently, those of skill in the art can recognize that the present invention is applicable to other types of project or product development activities in which the integration of legal agreement generation into a development process is desirable.

FIG. 2 is a key to FIGS. 2A-2C illustrating a process flow diagram of a method 200 implemented by SOW tool system 100 for generating a new Statement of Work (SOW) in accordance with one embodiment of the present invention. Referring to FIGS. 1 and 2 together, according to method 200, in one embodiment, in an enter/login operation 202, a user, such as an engineer of a project development group, initiates start up of SOW tool program 106. For example, the engineer accesses user computer terminal 116 and inputs selection of SOW tool program 106, such as by selecting SOW tool program 106 from a directory menu, a menu bar, or an icon on user computer terminal 116.

In response to selection of SOW tool program 106, a login procedure is initiated. For example, the engineer enters and submits a login name/identifier(ID) and password to a login graphical user interface(GUI) displayed on user computer terminal 116. SOW tool program 106 receives the login data and determines if the login is valid, for example by comparing the login name/ID and password to a database of login names/IDs and passwords earlier input to SOW tool program 106 and stored in internal SOW tool database 108. If the login is invalid, an invalid login GUI is displayed on user computer terminal 116. The invalid login GUI includes options whether to login again or to exit SOW tool program 106.

If the login is valid, the login procedure is exited and the engineer is given access to SOW tool program 106. Login procedures, login names/IDs, and passwords are well known to those of skill in the art and are not further described herein to avoid detracting from the description of the present invention. When a valid login is input to SOW tool program 106, from ENTER/LOGIN operation 202, flow moves to a DISPLAY MAIN MENU GUI operation 204.

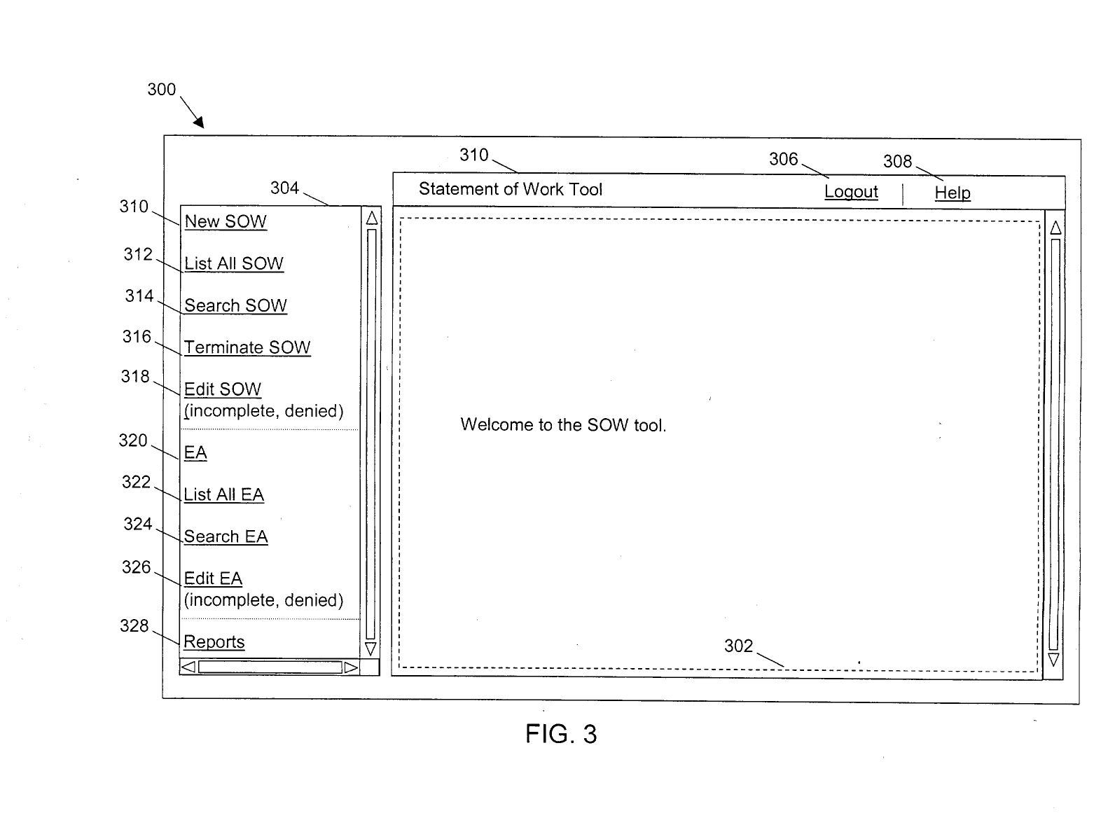

In DISPLAY MAIN MENU GUI operation 204, SOW tool program 106 displays a main menu GUI on user computer terminal 116. In one embodiment, the main menu GUI permits the engineer to initiate generation of a legal agreement such as a Statement of Work (SOW) or Engagement Agreement (EA). The main menu GUI is further described herein with reference to FIG. 3.

FIG. 3 illustrates an example of a main menu GUI 300 generated by SOW tool system 100 in accordance with one embodiment of the present invention. As illustrated in FIG. 3, in one embodiment, main menu GUI 300 includes a display area 302 and a selection panel 304 including one or more selectable options, such as: a New SOW option 310; a List All SOW option 312; a Search SOW option 314; a Terminate SOW option 316; an Edit SOW option 318; an EA (Engagement Agreement) option 320; a List All EA option 322; a Search EA option 324; an Edit EA 326; and, a Reports option 328, collectively referred to as the main menu selection options.

In one embodiment, selection of New SOW option 310 initiates generation of a new SOW. Selection of List All SOW option 312 displays all SOWs in internal SOW tool database 108. Selection of Search SOW option 314 initiates a search process in which the engineer can selectively search for SOWs in internal SOW tool database 108. Selection of Terminate SOW option 316 initiates a process for terminating a SOW. Selection of Edit SOW option 318 permits the engineer to edit a saved or denied SOW.

Selection of EA option 320 initiates generation of a new EA. Selection of List All EA option 322 displays all EAs in internal SOW tool database 108. Selection of Search EA option 324 initiates a search process in which the engineer can selectively search for EAs in internal SOW tool database 108. Selection of Edit EA option 326 initiates a process for terminating an EA. Selection of Reports option 328 initiates the generation of reports summarizing the status of EAs or SOWs for time periods selected by the engineer.

In one embodiment, a Logout option 306 and a Help option 308 are also included in main menu GUI 300 in a title bar 310. Logout option 306 automatically logs the engineer out of SOW tool program 106; and Help option 308 permits the engineer to locate help instructions to assist the engineer in using SOW tool program 106. In one embodiment, the help instructions are stored in internal SOW tool database 108. Logout and help options are well known to those of skill in the art and are not further described herein to avoid detracting from the description of the present invention.

In one embodiment, selection panel 304 and title bar 310 are included in successive GUIs displayed on user computer terminal 116. From DISPLAY MAIN MENU GUI operation 204, flow moves to a RECEIVE NEW SOW OPTION SELECTION operation 206.

Referring now to FIGS. 1-3 together, in RECEIVE NEW SOW OPTION SELECTION operation 206, via user computer terminal 116, the engineer inputs selection of New SOW option 310 and submits the selection to SOW tool program 106, for example, by double clicking on New SOW option 310 in selection panel 304. The selection of New SOW option 310 is received by SOW tool program 106. From RECEIVE NEW SOW OPTION SELECTION operation 206, flow moves to a DISPLAY CUSTOMER NAME GUI operation 208.

In response to receiving selection of New SOW option 310, in DISPLAY CUSTOMER NAME GUI operation 208, SOW tool program 106 displays a customer name GUI on user computer terminal 116. In one embodiment, the customer name GUI includes a field for inputting a customer name or customer identifier (ID) for whom a new SOW is to be initiated. From DISPLAY CUSTOMER NAME GUI operation 208, flow moves to a RECEIVE CUSTOMER NAME operation 210.

In RECEIVE CUSTOMER NAME operation 210, via user computer terminal 116, the engineer inputs the name or identifier of the customer into a customer name/ID field of the customer name GUI and submits the customer name/ID to SOW tool program 106, such as by clicking on a next, continue, or submit button in the customer name GUI. The input of the customer name data is received by SOW tool program 106. From RECEIVE CUSTOMER NAME operation 210, flow moves to an EA check operation 212.

Upon receiving submission of the customer name, in EA check operation 212, SOW tool program 106 determines if an engagement agreement (EA) exists for the customer name received in RECEIVE CUSTOMER NAME operation 210. In one embodiment, SOW tool program 106 determines if an EA exists for the customer name by checking the name against data stored in internal SOW tool database 108. If an EA does not exist for the customer name, from EA check operation 212, flow moves to a DISPLAY NO EA GUI operation 214.

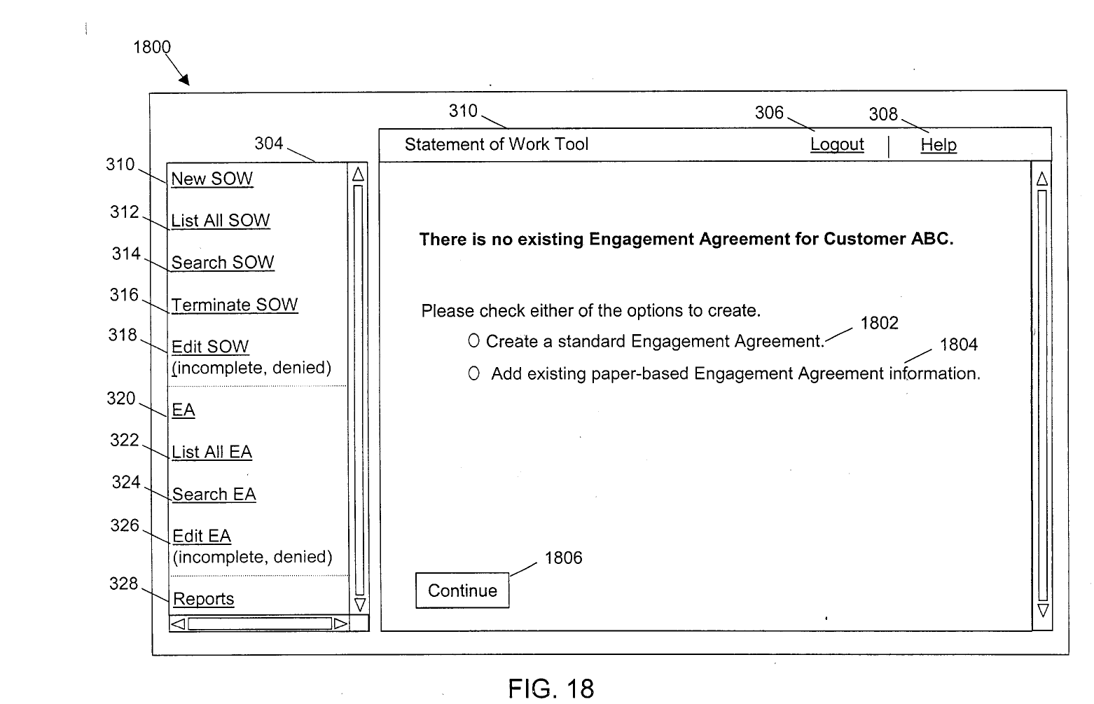

In DISPLAY NO EA GUI operation 214, a No EA GUI is displayed on user computer terminal 116 notifying the engineer that an EA does not exist for the customer and providing the engineer a selectable option to create an EA. In one embodiment, the No EA GUI includes options to generate an EA utilizing SOW tool system 100 or to input data from an existing paper-based EA. An example of a No EA GUI including an option to input data from an existing paper-based EA is further described herein with reference to FIG. 18. From DISPLAY NO EA GUI operation 214, flow moves to a RECEIVE EA OPTION SELECTION operation 216.

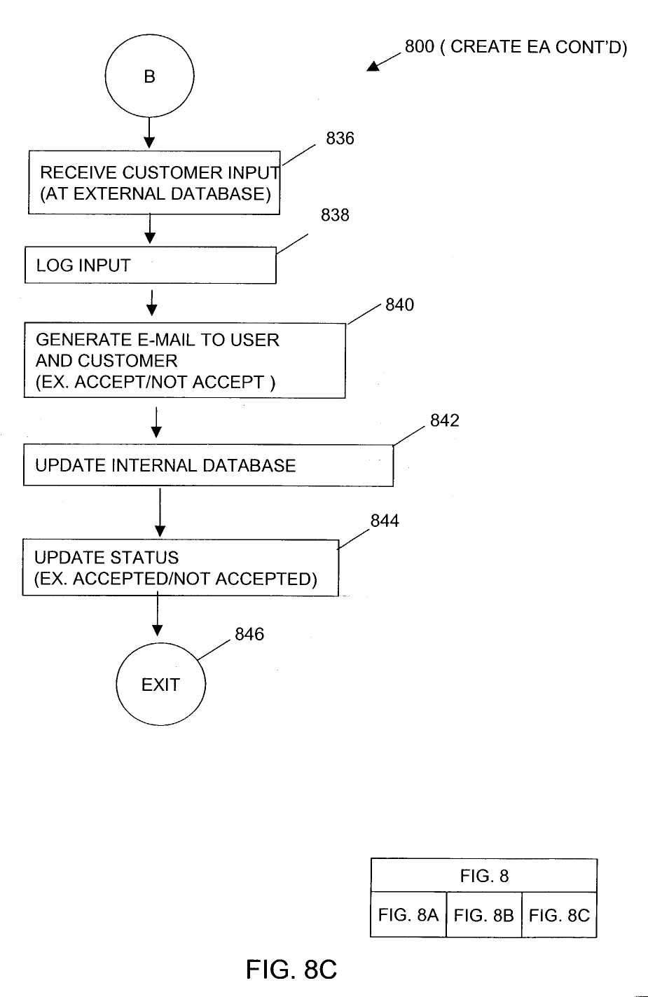

In RECEIVE EA OPTION SELECTION operation 216, via user computer terminal 116, the engineer inputs selection of a create EA option and submits the selection to SOW tool program 106, for example, by double clicking on a create standard EA option. The selection of the create standard EA option is received by SOW tool program 106. From RECEIVE EA OPTION SELECTION operation 216, flow moves to a CREATE EA operation 218. CREATE EA operation 218 is further described herein with reference to method 800 and FIG. 8.

Returning to EA check operation 212, if an EA exists for the customer name received in RECEIVE CUSTOMER NAME operation 210, flow moves from EA check operation 212 to a DISPLAY NEW SOW GUI operation 220.

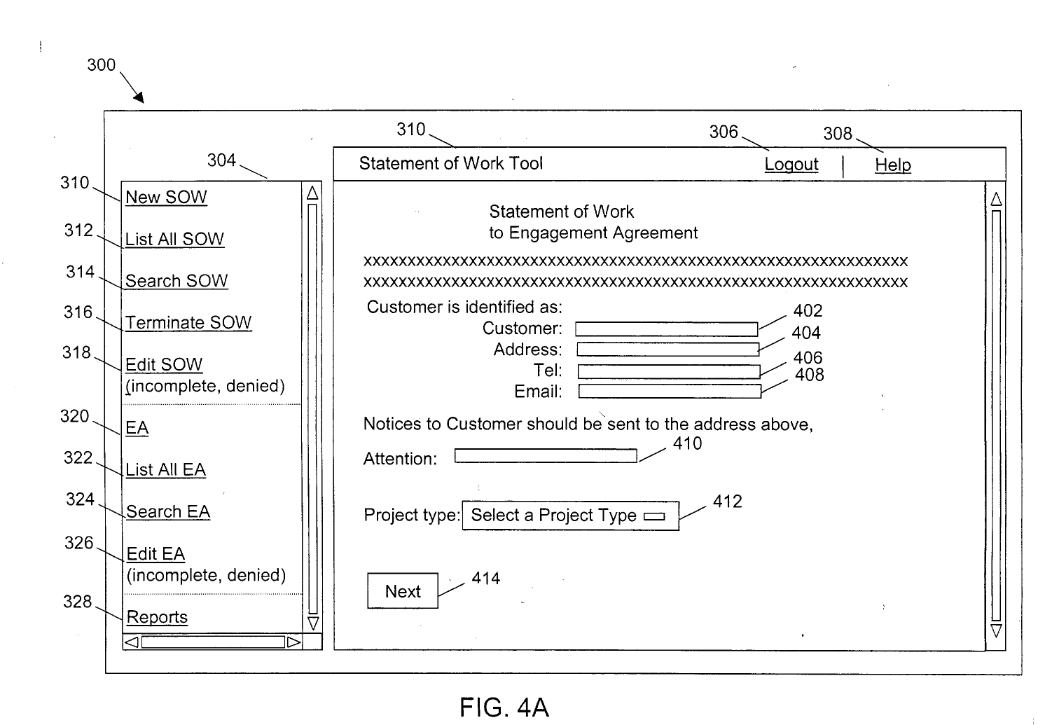

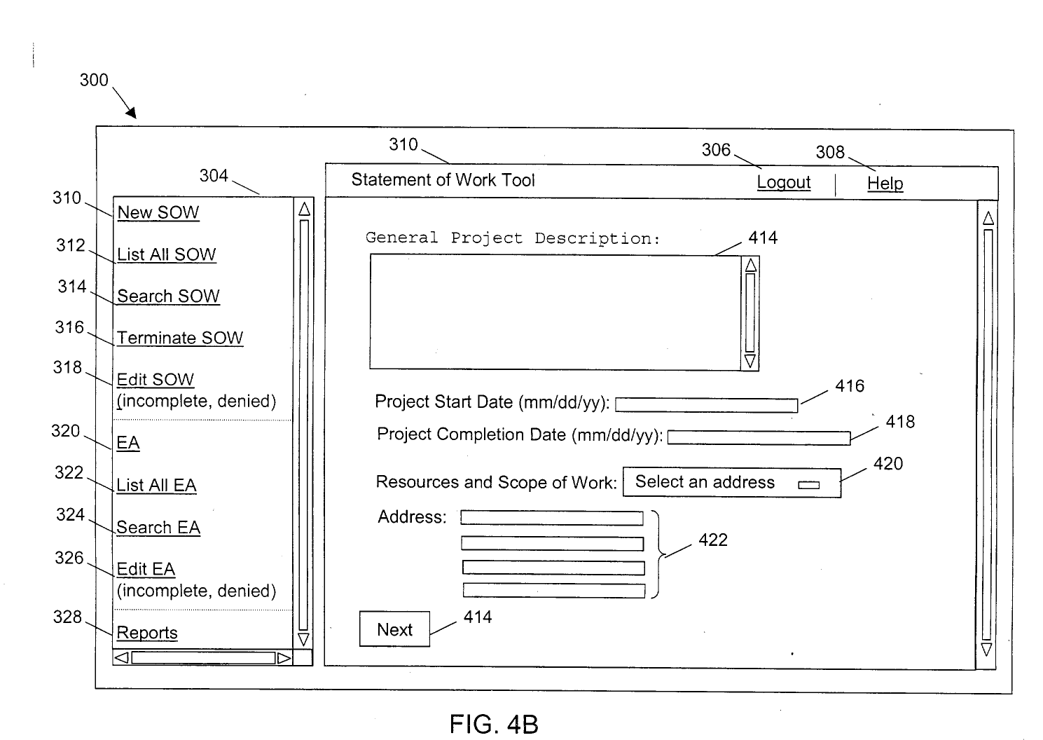

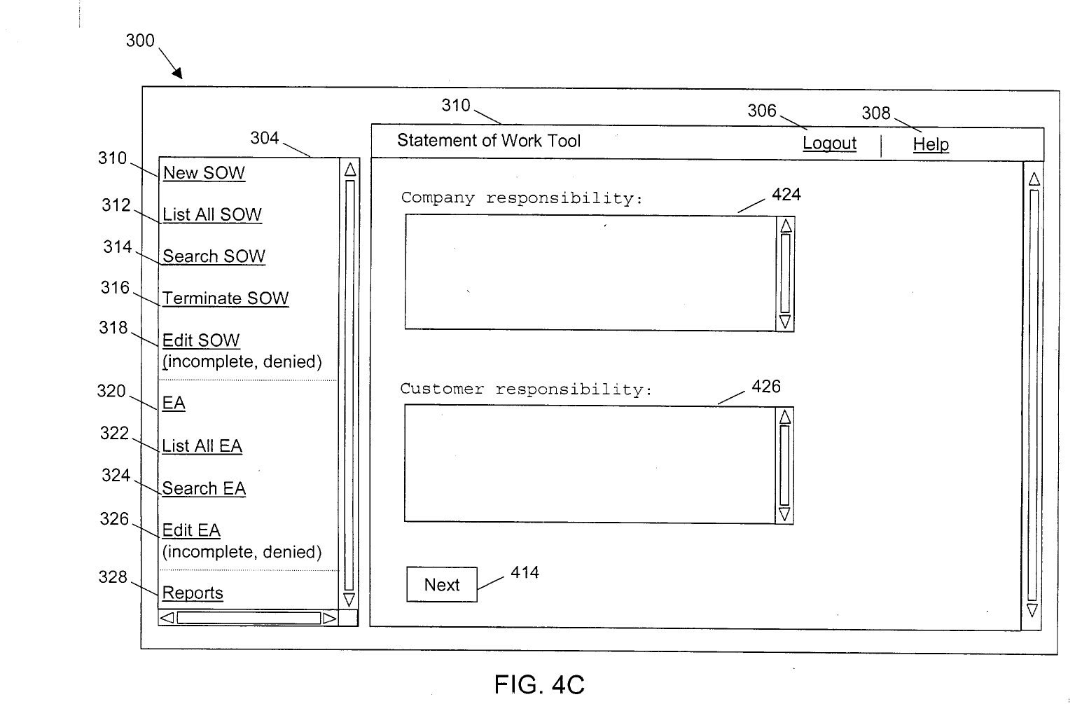

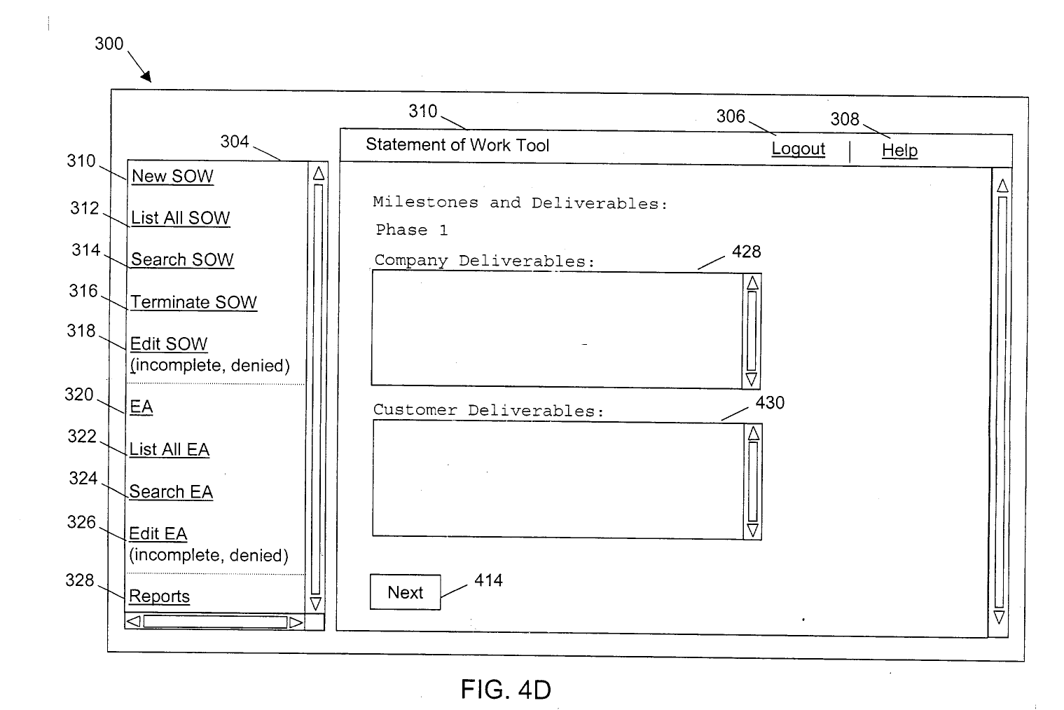

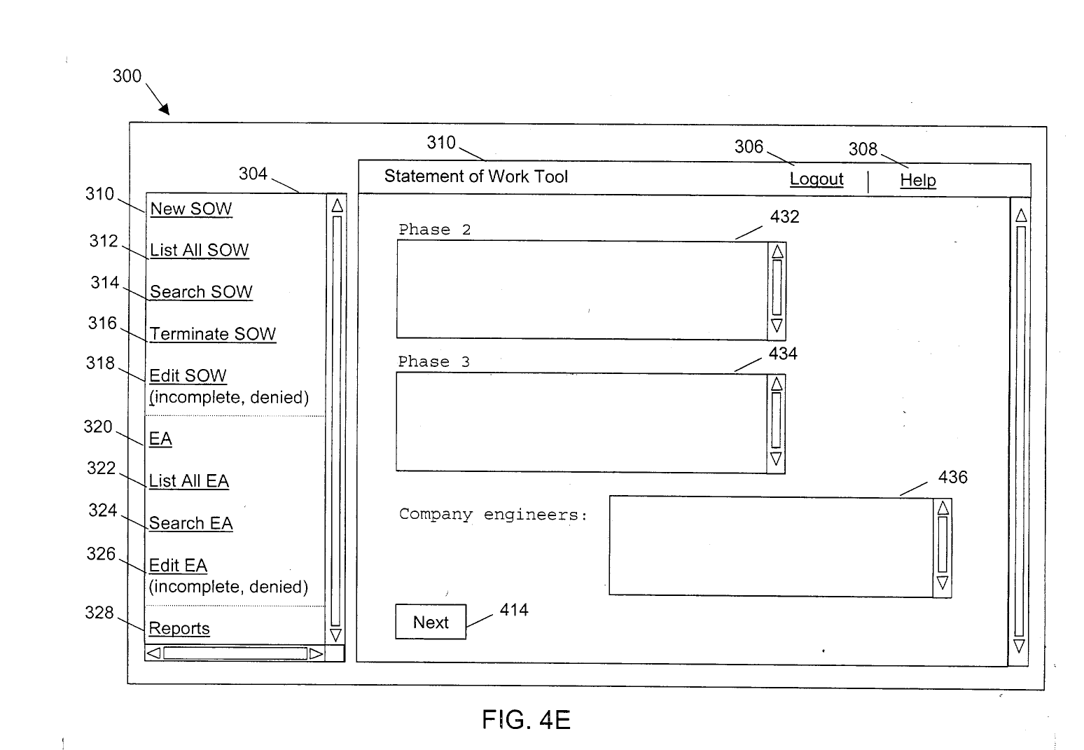

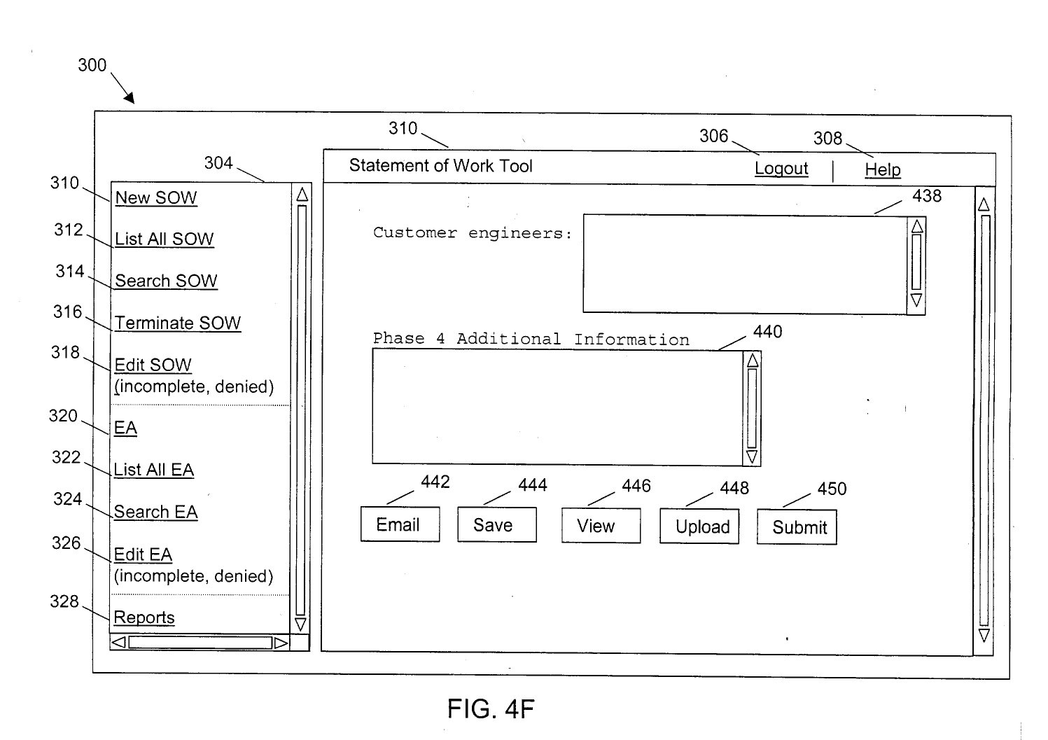

In DISPLAY NEW SOW GUI operation 220, a new SOW GUI is displayed on user computer terminal 116. In one embodiment, the new SOW GUI is composed of several new SOW GUI segments progressed through by selecting display of a next new SOW GUI segment, such as by clicking on a next or continue button of a particular new SOW GUI segment. In other embodiments, the new SOW GUI can be scrolled through. The new SOW GUI is further described herein with reference to FIGS. 4A-4F.

FIGS. 4A-4F illustrate an example of a new SOW GUI 400 generated by SOW tool system 100 in accordance with one embodiment of the present invention. Referring to FIGS. 1-4F together, in the present embodiment, new SOW GUI 400 is progressed through by clicking on a next button 414. New SOW GUI 400 includes one or more data fields used in generating a new SOW with SOW tool program 106. In one embodiment, SOW tool program 106 prefills any fields having available data in the internal SOW tool database 108, PE tool database 112, and/or directory database 114.

Referring to FIG. 4A, in one embodiment, new SOW GUI 400 includes: a customer field 402; an address field 404; a telephone (number) field 406; an e-mail (address) field 408; an attention field 410; and a project type pull-down menu 412.

In one embodiment, SOW tool program 106 stores SOW templates in internal SOW tool database 108 that are tailored to address the requirements for different project types. In the present embodiment, project type pull-down menu 412 is a pull-down menu of different project types. Selection of one of the project types in the pull-down menu determines the SOW template utilized by SOW tool program 106. In one embodiment, selection of a project type also determines the information (including, fields, pull-down menus, notes, and layout) of the new SOW GUI displayed to the engineer. Selection of next button 414 results in display of a next new SOW GUI segment illustrated in FIG. 4B.

Referring to FIG. 4B, in one embodiment, new SOW GUI 400 further includes: a scrollable general project description field 414; a project start date field 416; a project completion date field 418; an address pull-down menu 420; and one or more address fields 422. In one embodiment, address pull-down menu 420 includes company project locations, such as specific development lab addresses, which can be selected and automatically entered in address field(s) 422 by SOW tool program 106. If an address is not available in address pull-down menu 420, an address can be manually input into address field(s) 422 by the engineer. Selection of next button 414 results in display of a next new SOW GUI segment illustrated in FIG. 4C.

Referring to FIG. 4C, in one embodiment, new SOW GUI 400 further includes: a scrollable company responsibility field 424; and a scrollable customer responsibility field 426. Selection of next button 414 results in display of a next new SOW GUI segment illustrated in FIG. 4D.

Referring to FIG. 4D, in one embodiment, new SOW GUI 400 further includes: a scrollable phase 1 company deliverables field 428; and a scrollable phase 1 customer deliverables field 430. Selection of next button 414 results in display of a next new SOW GUI segment illustrated in FIG. 4E.

Referring to FIG. 4E, in one embodiment, new SOW GUI 400 further includes: a scrollable phase 2 description field 432; a scrollable phase 3 description field 434; and a scrollable company engineers field 436. Selection of next button 414 results in display of a next new SOW GUI segment illustrated in FIG. 4F.

Referring to FIG. 4F, in one embodiment, new SOW GUI 400 further includes: a scrollable customer engineers field 438; and a phase 4 additional information field 440. At the end of new SOW GUI 400, in one embodiment, a submit button 450 is included to permit the engineer to submit the new SOW data input in the fields (and selected from pull-down menus) to SOW tool program 106. The engineer submits the new SOW data to internal SOW tool program 106, for example, by clicking on submit button 450.

In one embodiment, new SOW GUI 400 further includes: an email button 442; a save button 444; a view button 446; and, an upload button 448. Selection of email button 442 saves the input new SOW data to internal SOW tool database 108 and e-mails the new SOW data to the address entered in email field 408 (FIG. 4A). In other embodiments, selection of email button 442 results in display of an email GUI in which the user can input a desired email address to which to send the new SOW data.

Selection of save button 444 saves the new SOW data to internal SOW tool database 108 in incomplete status as the new SOW still needs to be submitted for legal approval. The saved new SOW data can be edited by selecting Edit SOW option 318. Selection of view button 446 displays the formatted new SOW, e.g., a view of the input new SOW data incorporated in an SOW template. Selection of upload button 448 copies an existing SOW to a new SOW. In one embodiment, the engineer can tag an existing SOW and then upload the data into a new SOW. From DISPLAY NEW SOW GUI operation 220, flow moves to a RECEIVE NEW SOW DATA operation 222.

In response to submitting the new SOW data, in RECEIVE NEW SOW DATA operation 222, SOW tool program 106 receives the new SOW data and stores the new SOW data in internal SOW tool database 108. From RECEIVE NEW SOW DATA operation 222, flow moves to a POST NEW SOW TO INTERNAL DATABASE operation 224.

In POST NEW SOW TO INTERNAL DATABASE operation 224, SOW tool program 106 incorporates the new SOW data with a stored SOW template to generate a SOW. In one embodiment, a portable document format (pdf) version of the new SOW including at least some of the data submitted from new SOW GUI 400 is posted to an address location on internal network 102, such as to internal SOW tool database 108. In other embodiments, other viewable documents formats can also be used. From POST NEW SOW TO INTERNAL DATABASE operation 224, flow moves to a GENERATE E-MAIL TO LEGAL operation 226.

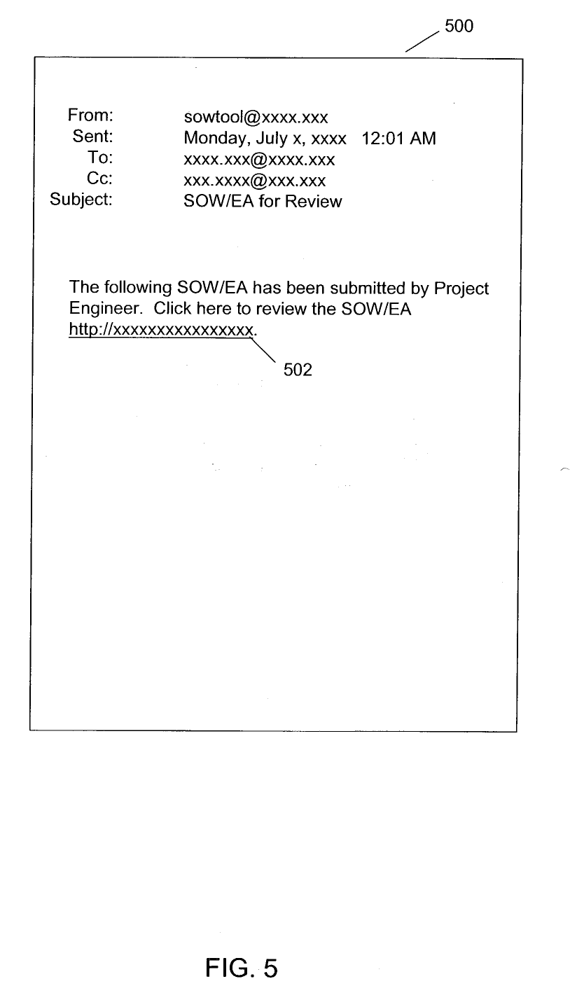

In GENERATE E-MAIL TO LEGAL operation 226, SOW tool program 106 automatically generates an e-mail to a legal representative (of a legal department) including a notice that a new SOW is available for review by the legal representative and the address on internal network 102 where the pdf version of the new SOW can be reviewed by the legal representative. In one embodiment, the address is a selectable link to the address. In one embodiment, the address of the new SOW is a location in internal SOW tool database 108. An example of an e-mail generated and sent to the legal representative including notification of a new SOW for review is further described herein with reference to FIG. 5.

FIG. 5 illustrates an example of an e-mail 500 generated by SOW tool system 100 in accordance with one embodiment of the present invention. As illustrated in FIG. 5, in one embodiment, e-mail 500 includes a notice that a new SOW or EA has been submitted for review and the URL address 502 where the new SOW or EA can be viewed.

In one embodiment, a confirmation message is sent to the engineer including a confirmation that the e-mail was sent to the legal representative to review the new SOW and the e-mail address of the legal representative. In one embodiment, SOW tool program 106 obtains the information from directory database 114.

From GENERATE E-MAIL TO LEGAL operation 226, flow moves to an UPDATE STATUS operation 228.

In UPDATE STATUS operation 228, SOW tool program 106 updates the status of the new SOW to indicate it is in legal processing. For example, a status indicator stored in a status field of internal SOW tool database 108 associated with the new SOW is updated to “Legal Processing”. From UPDATE STATUS operation 228, flow moves to a RECEIVE LEGAL INPUT operation 230.

In RECEIVE LEGAL INPUT operation 230, via legal computer terminal 118, the legal representative accesses the pdf version of the new SOW at the address in the e-mail generated by SOW tool program 106 in GENERATE E-MAIL TO LEGAL operation 226. The legal representative reviews the new SOW, for example, by scrolling through the new SOW and determines whether to approve or deny the new SOW.

In one embodiment, at the end of the new SOW, the legal representative inputs the approve or the deny determination by selecting an approve option or a deny option, for example, by clicking on an approve button or deny button. The approve selection or the deny selection is received by SOW tool program 106. From RECEIVE LEGAL INPUT operation 230, flow moves to an APPROVE NEW SOW check operation 232.

In APPROVE NEW SOW check operation 232, SOW tool program 106 determines whether the new SOW was approved or denied by the legal representative based on the input received in RECEIVE LEGAL INPUT operation 230. If the legal department representative denies approval of the new SOW, from APPROVE NEW SOW check operation 232, flow moves to a DISPLAY REASONS GUI operation 234.

In DISPLAY REASONS GUI operation 234, SOW tool program 106 displays a Reasons GUI on legal computer terminal 118 providing a field where the legal representative can input reasons for the denial of the new SOW. From DISPLAY REASONS GUI operation 234, flow moves to a RECEIVE LEGAL INPUT operation 236.

In RECEIVE LEGAL INPUT operation 236, the legal representative enters any reasons for denial of the SOW and submits the reasons, for example, by clicking on a next button on the Reasons GUI. SOW tool program 106 receives the input data. From RECEIVE LEGAL INPUT operation 236, flow moves to an UPDATE STATUS operation 238.

In UPDATE STATUS operation 238, SOW tool program 106 updates the status of the new SOW to indicate it is denied by legal. For example, a status indicator stored in a status field of internal SOW tool database 108 associated with the new SOW is updated to “Denied”. From UPDATE STATUS operation 238, flow moves to a GENERATE E-MAIL TO USER operation 240.

In GENERATE E-MAIL TO USER operation 240, SOW tool program 106 automatically generates and sends an e-mail to the engineer including reasons for the denial of the new SOW. From GENERATE E-MAIL TO USER operation 240, flow moves to an EDIT SOW operation 242.

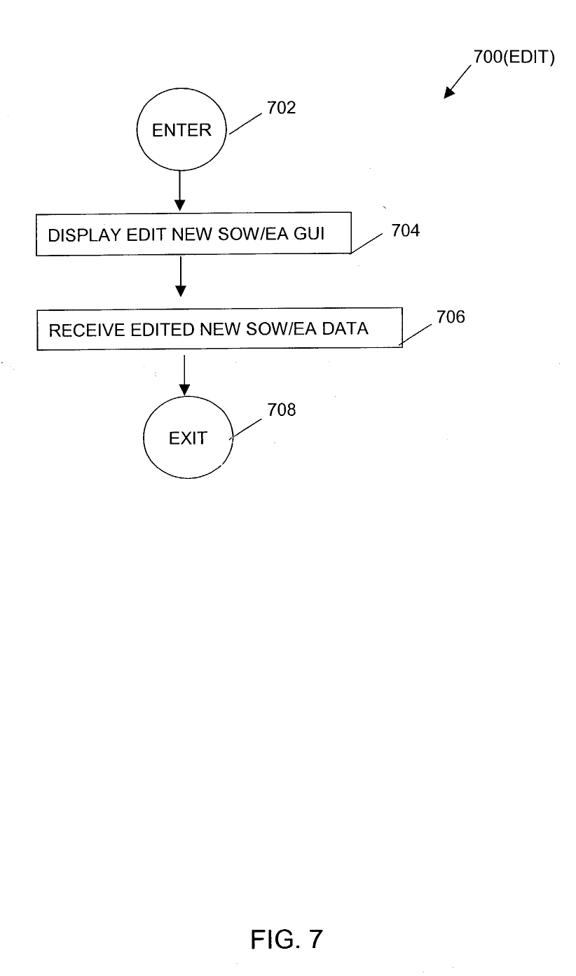

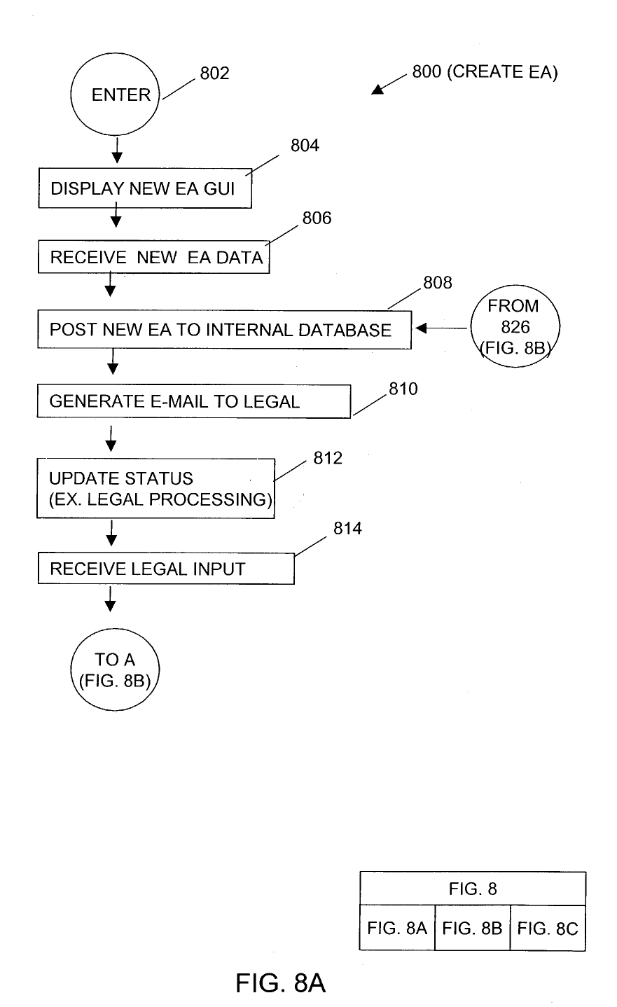

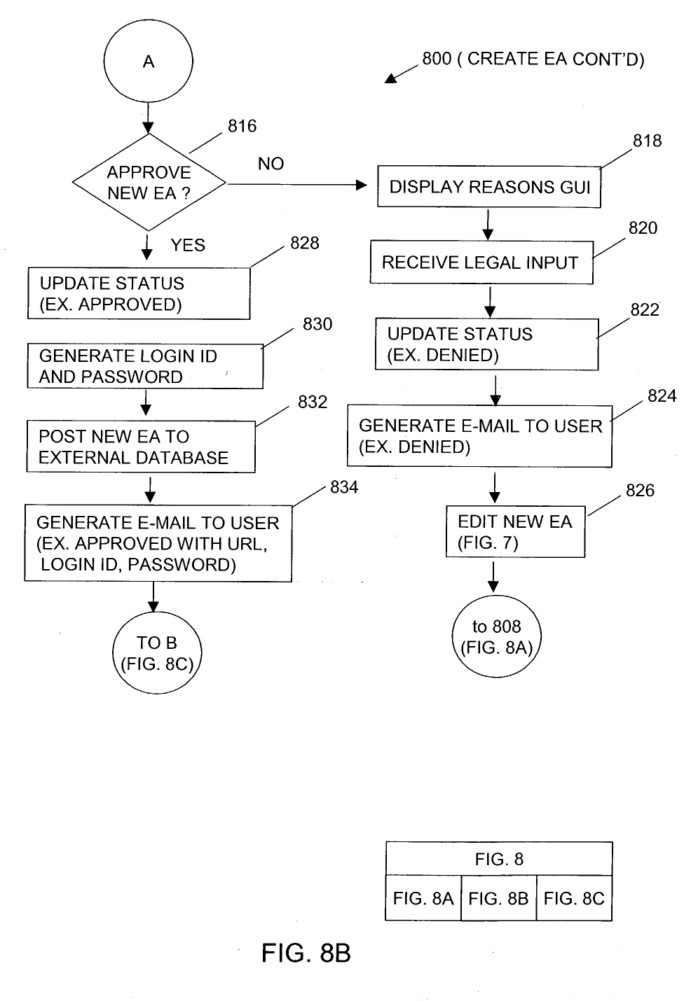

In EDIT SOW operation 242, the engineer receives the e-mail generated in GENERATE E-MAIL TO USER operation 240. If so desired, the engineer can then edit the SOW and resubmit the revised SOW to process 200 at POST NEW SOW TO INTERNAL DATABASE operation 224. EDIT SOW operation 242 is further described herein with reference to a method 700 and FIG. 7 for editing a new SOW or EA.

Returning to APPROVE NEW SOW check operation 232, if the legal representative approves the new SOW, from APPROVE NEW SOW check operation 232, flow moves to an UPDATE STATUS operation 244.

In UPDATE STATUS operation 244, SOW tool program 106 updates the status of the new SOW to indicate it is approved by legal. For example, a status indicator stored in a status field of internal SOW tool database 108 associated with the new SOW is updated to “Approved”. From UPDATE STATUS operation 244, flow moves to a GENERATE LOGIN ID AND PASSWORD operation 246.

In GENERATE LOGIN ID AND PASSWORD operation 246, SOW tool program 106 automatically generates a unique login identifier (ID) and password for use in accessing the approved new SOW by the customer. In one embodiment, the unique login ID and password are stored in internal SOW tool database 108. From GENERATE LOGIN ID AND PASSWORD operation 246, flow moves to a POST NEW SOW TO EXTERNAL DATABASE operation 248.

In POST NEW SOW TO EXTERNAL DATABASE operation 248, SOW tool program 106 automatically posts the new SOW on external SOW tool database 124. In one embodiment, SOW tool program 106 automatically accesses external server 122 via external network 120 and posts the new SOW in external SOW tool database 124 at a location having a specific URL address. In one embodiment, the specific URL address is stored in the internal SOW tool database 108. From POST NEW SOW TO EXTERNAL DATABASE operation 248, flow moves to a GENERATE E-MAIL TO USER operation 250.

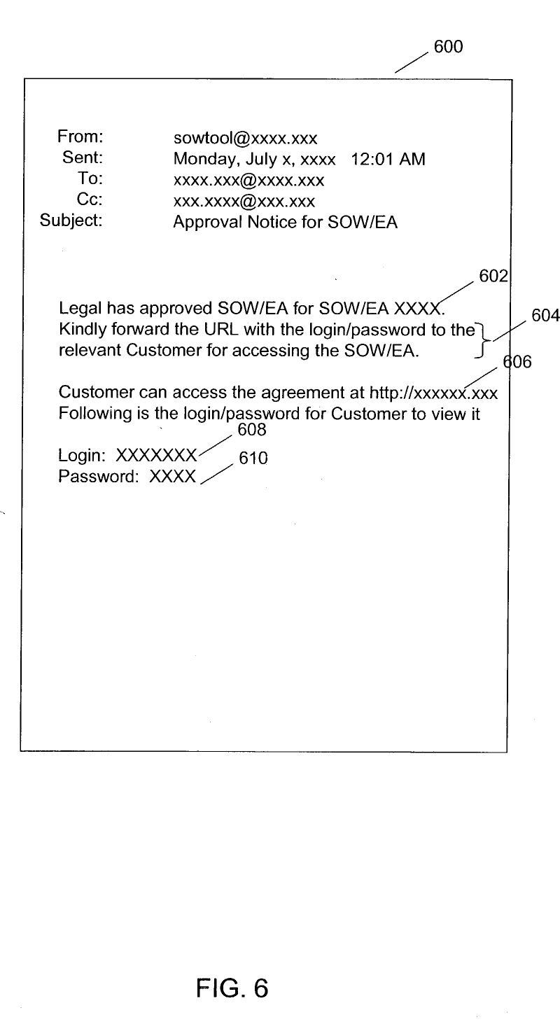

In GENERATE E-MAIL TO USER operation 250, SOW tool program 106 automatically generates and sends an e-mail message to the engineer including a notification of the approval of the new SOW by the legal department representative. In one embodiment, the e-mail further includes the unique login ID and password generated in GENERATE LOGIN ID AND PASSWORD operation 246, as well as, the URL address where the customer can access the new SOW at external SOW tool database 124 on external network 120. An example of the e-mail generated by SOW tool program 106 to the engineer including notification of the approval of the new SOW, the login ID, password and URL address is further described herein with reference to FIG. 6.

FIG. 6 illustrates an example of an e-mail 600 generated by SOW tool system 100 in accordance with one embodiment of the present invention. As illustrated in FIG. 6, in one embodiment, e-mail 600 includes a notice 602 that a new SOW or EA has been approved by legal, instructions 604 for the engineer to forward the URL address with the login and password to the customer, a URL address 606 where the customer can access the new SOW or EA, a login (ID) 608, and a password 610. From GENERATE E-MAIL TO USER operation 250, flow moves to a RECEIVE CUSTOMER INPUT operation 252.

Upon receipt of the e-mail generated in GENERATE E-MAIL TO USER operation 250, in RECEIVE CUSTOMER INPUT operation 252,the submitting engineer is then responsible for generating an e-mail to the customer advising the customer of the URL address, login ID and password. In one embodiment, the engineer merely forwards the e-mail generated in GENEREATE E-MAIL TO USER operation 250 to the customer.

Once the new SOW is posted to external SOW tool database 124, in one embodiment, the customer has a specified amount of time during which to accept or not accept the new SOW. In one embodiment, after the specified amount of time has expired, the new SOW is withdrawn from posting on external database 124 and another new SOW must be initiated by the engineer in order to obtain an acceptance by the customer.

To access the new SOW, via customer computer terminal 126, the customer accesses the URL address on external network 120. In one embodiment, a login GUI having a login ID field and a password field are displayed to the customer on customer computer terminal 126. The customer inputs the login ID and password, sent in the e-mail from the engineer, into the respective fields on the login GUI and submits the data, such as by clicking on a next, continue, or submit button on the login GUI.

Upon submission of a valid login ID and password, the new SOW is displayed to the customer on customer computer terminal 126. In one embodiment, the pdf version of the new SOW is displayed to the customer. In one embodiment, the customer scrolls through the new SOW and determines whether to accept or not accept the new SOW. In one embodiment, an accept button and a do not accept button are displayed to the customer at the end of the new SOW. The customer selects and submits the acceptance or non-acceptance to external SOW tool database 124, for example, by clicking on the accept or the do not accept button. External SOW tool database 124 receives the customer input. From RECEIVE CUSTOMER INPUT operation 252, flow moves to a LOG INPUT operation 254.

In LOG INPUT operation 254, external SOW tool database 124 logs the acceptance or non-acceptance and the date and time of the acceptance or non-acceptance of the new SOW. From LOG INPUT operation 254, flow moves to a GENERATE E-MAIL TO USER AND CUSTOMER operation 256.

IN GENERATE E-MAIL TO USER AND CUSTOMER operation 256, an e-mail is automatically generated by external SOW tool database 124 and sent to the submitting engineer and customer confirming that the customer has accepted or not accepted the new SOW. In one embodiment, the e-mail includes the date and time of acceptance or non-acceptance. From GENERATE E-MAIL TO USER AND CUSTOMER operation 256, flow moves to an UPDATE INTERNAL SOW TOOL DATABASE operation 258.

In UPDATE INTERNAL DATABASE operation 258, information logged to external SOW tool database 124 is periodically downloaded to internal network 102 and SOW tool program 106 to update internal SOW tool database 108, for example, via a cron job initiated by SOW tool program 106. From UPDATE INTERNAL DATABASE operation 258, flow moves to an UPDATE STATUS operation 260.

When SOW tool program 106 receives the updated data, in UPDATE STATUS operation 260, SOW tool program 106 updates internal SOW tool database 108 including the status of the new SOW in internal SOW tool database 108. If the customer accepted the new SOW, the status of the new SOW is changed to “Accepted” in internal SOW tool database 108 and the date and time of acceptance are added to internal SOW tool database 108.

If the customer did not accept the new SOW, the status of the new SOW is changed to “Not Accepted” in internal SOW tool database 108 and the date and time of non-acceptance are added to internal SOW tool database 108. From UPDATE STATUS operation 260, flow exits method 200 at an EXIT operation 262.

FIG. 7 illustrates a process flow diagram of a method 700 implemented by SOW tool system 100 for editing a new SOW or EA in accordance with one embodiment of the invention. Although method 700 is described herein with reference to editing of a new SOW, the process can also be applied to editing of a new EA.

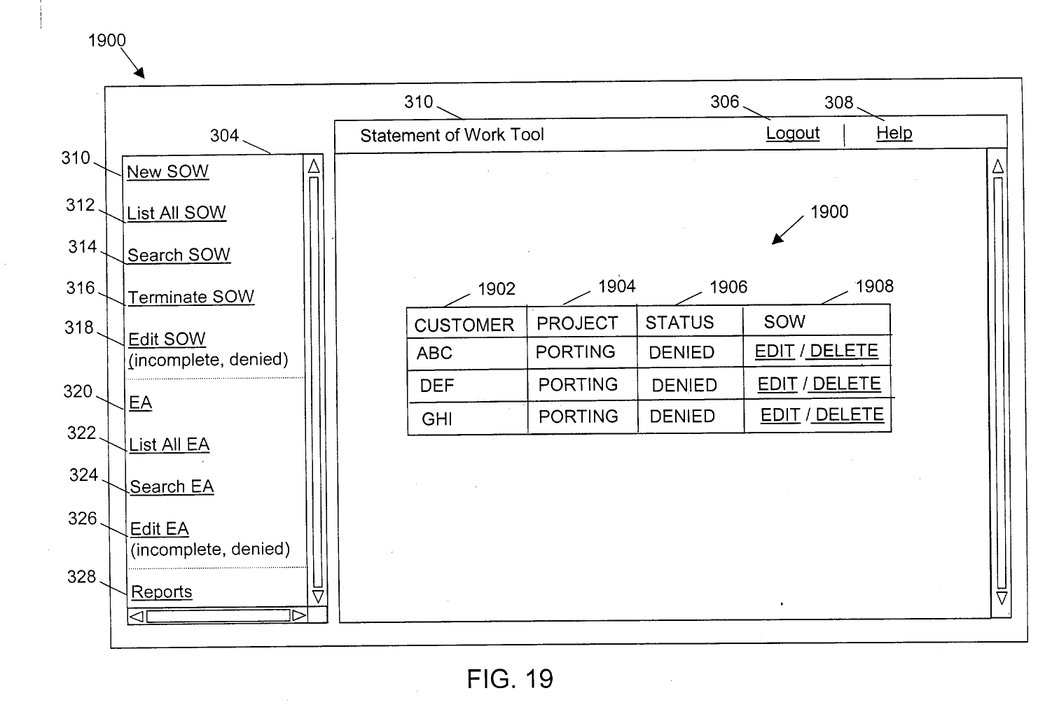

According to method 700, in one embodiment, the engineer enters method 700 to edit a new SOW at an enter operation 702. For example, the engineer can select Edit SOW option 318 in selection panel 304. In one embodiment, selection of Edit SOW option 318 results in display of a list including all SOW(s) available for editing or deleting. An example of a list generated by SOW tool system 100 in response to selection of Edit SOW option 318 is further described herein with reference to FIG. 19.

In one embodiment, the list of SOW(s) available for editing or deleting includes the name of the customer, the project, the status, and edit/delete options for each listed SOW. In one embodiment, selection of an edit option next to a particular SOW, inputs selection of method 700 for that particular SOW to SOW tool program 106. From ENTER operation 702, flow moves to a DISPLAY EDIT NEW SOW/EA GUI operation 704.

In DISPLAY EDIT NEW SOW/EA GUI operation 704, SOW tool program 106 displays an Edit New SOW GUI with the data originally submitted, or saved, by the engineer for the new SOW. FROM DISPLAY EDIT NEW SOW/EA GUI operation 704, flow moves to RECEIVE EDITED NEW SOW/EA DATA operation 706.

In RECEIVE EDITED NEW SOW/EA DATA operation 706, the engineer edits the data in the displayed EDIT NEW SOW/EA GUI. For example, if the legal representative input reasons for denial of the new SOW, the engineer can revise the new SOW to incorporate those changes. At the end of the new SOW, the engineer can submit the revised new SOW to SOW tool program 106, for example, by clicking on a submit button. In this instance of editing a new SOW, from RECEIVE EDITED NEW SOW/EA DATA operation 706, flow returns to process 200 at POST NEW SOW TO INTERNAL DATABASE operation 224, where a revised new SOW is generated and method 200 continues as earlier described with reference to FIGS. 1-6.

FIG. 8 is a key to FIGS. 8A through 8C illustrating a process flow diagram of a method 800 implemented by SOW tool system 100 for generating a new Engagement Agreement (EA) in accordance with one embodiment of the present invention. Referring to FIGS. 1-8 together, in one embodiment, in an ENTER operation 802, via user computer terminal 116, the engineer enters method 800 either by selecting and submitting EA option 320 in main menu GUI 300 or from RECEIVE EA OPTION SELECTION operation 216 of method 200. From ENTER operation 802, flow moves to a DISPLAY NEW EA GUI operation 804.

In DISPLAY NEW EA GUI operation 804, SOW tool program 106 displays a New EA GUI on user computer terminal 116. In one embodiment, the New EA GUI is composed of several New EA GUI segments progressed through by selecting display of a next New EA GUI segment, such as by clicking on a next or continue button of a particular New EA GUI segment. In other embodiments, the New EA GUI can be scrolled through.

Similar to the New SOW GUI, the New EA GUI includes fields, and/or pull-down menus and selection buttons that permit the engineer to input data needed to create a new EA. In one embodiment, SOW tool program 106 prefills selected fields for which data is available from PE tool database 112 and or directory database 114. The engineer submits the new EA data to SOW tool program 106, for example, by clicking on a submit button at the end of the New EA GUI. From DISPLAY NEW EA GUI operation 804 flow moves to a RECEIVE NEW EA DATA operation 806.

In response to submitting the new EA data, in RECEIVE NEW EA DATA operation 806, SOW tool program 106 receives the new EA data and stores the new EA data in internal SOW tool database 108. From RECEIVE NEW EA DATA operation 806, flow moves to POST NEW EA TO INTERNAL DATABASE operation 808.

In POST NEW EA TO INTERNAL DATABASE operation 808, SOW tool program 106 incorporates the new EA data with a stored EA template to generate a new EA. A portable document format (pdf) version of the new EA including at least some of the data submitted from the NEW EA GUI is posted to an address location on internal network 102, such as to internal SOW tool database 108. In other embodiments, other viewable document formats can also be used. From POST NEW EA TO INTERNAL DATABASE operation 808, flow moves to a GENERATE E-MAIL TO LEGAL operation 810.

In GENERATE E-MAIL TO LEGAL operation 810, SOW tool program 106 automatically generates an e-mail to a legal representative (of the legal department) including a notice that a new EA is available for review by the legal representative and the address on internal network 102 where the pdf version of the new EA can be reviewed by the legal representative. In one embodiment, the address is a selectable link to the address. In one embodiment, the address of the new EA is a location in internal SOW tool database 108.

In one embodiment, a confirmation message is sent to the engineer including a confirmation that an e-mail was sent to the legal representative to review the new EA and the e-mail address of the legal representative. In one embodiment, SOW tool program 106 obtains the information from directory database 114. From GENERATE E-MAIL TO LEGAL operation 810, flow moves to an UPDATE STATUS operation 812.

In UPDATE STATUS operation 812, SOW tool 106 updates the status of the new EA to indicate it is in legal processing. For example, a status indicator stored in a status field of internal SOW tool database 108 associated with the new EA is updated to “Legal Processing”. From UPDATE STATUS operation 812, flow moves to a RECEIVE LEGAL INPUT operation 814.

In RECEIVE LEGAL INPUT operation 814, via legal computer terminal 118, the legal representative accesses the pdf version of the new EA at the address in the e-mail to legal generated by SOW tool program 106 in GENERATE E-MAIL TO LEGAL operation 810. The legal representative reviews the new EA, for example, by scrolling through the new EA and determines whether to approve or deny the new EA.

In one embodiment, at the end of the new EA, the legal representative inputs the approve or the deny determination by selecting an approve option or a deny option, for example, by clicking on an approve button or deny button. The approve selection or the deny selection is then received by SOW tool program 106. From RECEIVE LEGAL INPUT operation 814, flow moves to an APPROVE NEW EA check operation 816.

In APPROVE NEW EA check operation 816, SOW tool program 106 determines whether the new EA was approved or denied by the legal representative based on the input received in RECEIVE LEGAL INPUT operation 814. If the legal department representative denies approval of the new EA, from APPROVE NEW EA check operation 816, flow moves to a DISPLAY REASONS GUI operation 818.

In DISPLAY REASONS GUI operation 818, SOW tool program 106 displays a Reasons GUI on legal computer terminal 118 providing a field where the legal representative can input reasons for the denial of the new EA. From DISPLAY REASONS GUI operation 818, flow moves to a RECEIVE LEGAL INPUT operation 820.

In RECEIVE LEGAL INPUT operation 820, the legal representative enters any reasons for denial of the new EA and submits the reasons, for example, by clicking on a next button on the Reason GUI. SOW tool program 106 receives the input data. From RECEIVE LEGAL INPUT operation 820, flow moves to an UPDATE STATUS OPERATION 822.

In UPDATE STATUS operation 822, SOW tool 106 updates the status of the new EA to indicate it is denied by legal. For example, a status indicator stored in a status field of internal SOW tool database 108 associated with the new EA is updated to “Denied”. From UPDATE STATUS operation 822, flow moves to a GENERATE E-MAIL TO USER operation 824.

In GENERATE E-MAIL TO USER operation 824, SOW tool program 106 automatically generates and sends an e-mail to the engineer including reasons for the denial of the new EA. From GENERATE E-MAIL TO USER operation 824, flow moves to an EDIT NEW EA operation 826.

In EDIT NEW EA operation 826, the engineer receives the e-mail generated in GENERATE E-MAIL TO USER operation 824. If so desired, the engineer can then edit the new EA and resubmit the revised new EA to process 800 at POST NEW EA TO INTERNAL DATABASE operation 808. EDIT NEW EA operation 826 was earlier described herein with reference to method 700 and FIG. 7 for editing a new SOW or EA.

Returning to APPROVE NEW EA check operation 816, if the legal representative approves the new EA, from APPROVE NEW EA check operation 816, flow moves to an UPDATE STATUS operation 828.

In UPDATE STATUS operation 828, SOW tool 106 updates the status of the new EA to indicate it is approved by legal. For example, a status indicator stored in a status field of internal SOW tool database 108 associated with the new EA is updated to “Approved”. From UPDATE STATUS operation 828, flow moves to a GENERATE LOGIN ID AND PASSWORD operation 830.

In GENERATE LOGIN ID AND PASSWORD operation 830, SOW tool program 106 automatically generates a unique login identifier (ID) and password for use in accessing the approved new EA by the customer. In one embodiment, the unique login ID and password are stored in internal SOW tool database 108. From GENERATE LOGIN ID AND PASSWORD operation 830, flow moves to a POST NEW EA TO EXTERNAL DATABASE operation 832.

In POST NEW EA TO EXTERNAL DATABASE operation 832, SOW tool program 106 automatically posts the new EA on external SOW tool database 124. In one embodiment, SOW tool program 106 automatically accesses external server 122 via external network 120 and posts the new EA in external SOW tool database 124 at a specific URL address. In one embodiment, the specific URL address is stored in the internal. SOW tool database 108. From POST NEW EA TO EXTERNAL DATABASE operation 832, flow moves to a GENERATE E-MAIL TO USER operation 834.

In GENERATE E-MAIL TO USER operation 834, SOW tool program 106 automatically generates and sends an e-mail message to the engineer including a notification of the approval of the new EA by the legal department representative. In one embodiment, the e-mail further includes the unique login ID and password generated in GENERATE LOGIN ID AND PASSWORD operation 830, as well as, the URL address where the customer can access the new EA at external SOW tool database 124 on external network 120 (see. FIG. 6). From GENERATE E-MAIL TO USER operation 834, flow moves to RECEIVE CUSTOMER INPUT operation 836.

Upon receipt of the e-mail generated in GENERATE E-MAIL TO USER operation 834, in RECEIVE CUSTOMER INPUT operation 836, the engineer is then responsible for generating an e-mail to the customer advising the customer of the URL address, login ID and password. In one embodiment, the engineer merely forwards the e-mail generated in GENERATE E-MAIL TO USER operation 834 to the customer.

Once the new EA is posted to external SOW tool database 124, in one embodiment, the customer has a specified amount of time during which to accept or not accept the EA. In one embodiment, after the specified amount of time has expired, the new EA is withdrawn from posting on external database 124 and a new EA must be initiated by the engineer in order to obtain an acceptance by the customer.

To access the new EA, via customer computer terminal 126, the customer accesses the URL address on external network 120 as earlier described with reference to method 200 and FIG. 2. Upon submission of a valid login ID and password, the new EA is displayed to the customer on customer computer terminal 126. In one embodiment, the new EA is the pdf version of the new EA. In one embodiment, the customer scrolls through the new EA and determines whether to accept or not accept the new EA. In one embodiment, an accept button and a do not accept button are displayed to the customer at the end of the new EA. The customer selects and submits the acceptance or non-acceptance to external SOW tool database 124, for example, by clicking on the accept or the do not accept button. External SOW tool database 124 receives the customer input. From RECEIVE CUSTOMER INPUT operation 836, flow moves to a LOG INPUT operation 838.

In LOG INPUT operation 838, external SOW tool database 124 logs the acceptance or non-acceptance and the date and time of the acceptance or non-acceptance of the new EA. From LOG INPUT operation 838, flow moves to a GENERATE E-MAIL TO USER AND CUSTOMER operation 840.

In GENERATE E-MAIL TO USER AND CUSTOMER operation 840, an e-mail is automatically generated by external SOW tool database 124 and sent to the engineer and the customer confirming that the customer has accepted or not accepted the new EA. In one embodiment, the e-mail includes the date and time of acceptance or non-acceptance. From GENERATE E-MAIL TO USER operation 840, flow moves to an UPDATE INTERNAL DATABASE operation 842.

In UPDATE INTERNAL DATABASE operation 842, information logged to external SOW tool database 124 is periodically downloaded to internal network 102 and SOW tool program 106 to update internal SOW tool database 108, for example, via a cron job initiated by SOW tool program 106. From UPDATE INTERNAL DATABASE operation 842, flow moves to an UPDATE STATUS operation 844.

When SOW tool program 106 receives the updated data, in UPDATE STATUS operation 844, SOW tool program 106 updates internal SOW tool database 108 including the status of the new EA in internal SOW tool database 108. If the customer accepted the new EA, the status of the new EA is changed to “Accepted” in internal SOW tool database 108 and the date and time of acceptance are added to the database.

If the customer did not accept the new EA, the status of the new EA is changed to “Not Accepted” in internal SOW tool database 108 and the date and time of non-acceptance are added to the database. From UPDATE STATUS operation 844, flow exits method 800 at EXIT operation 846.

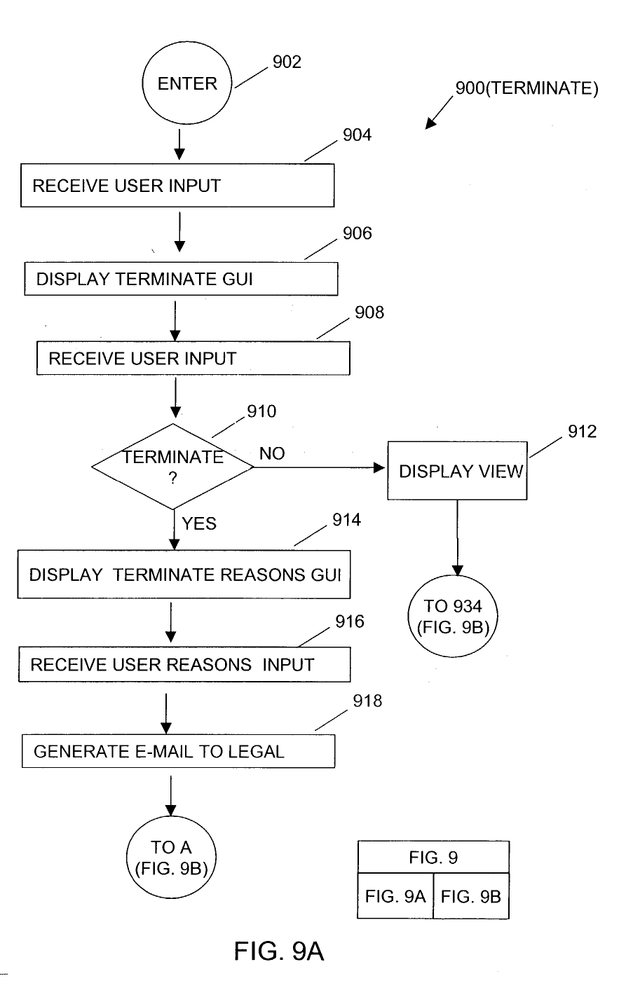

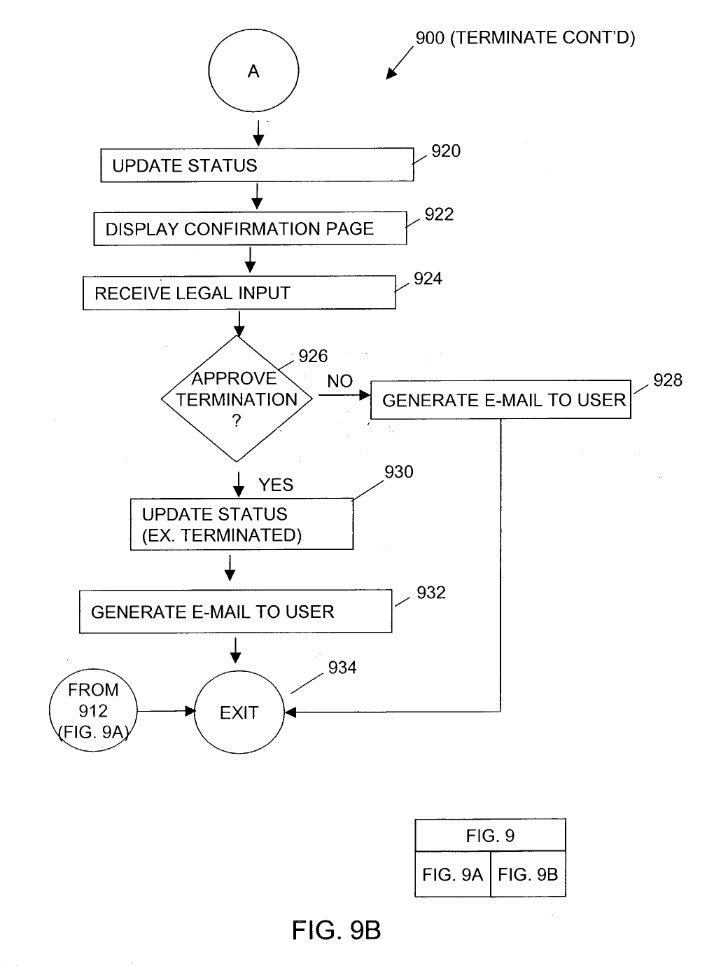

In some situations, it is desirable to terminate a legal agreement, and in one embodiment, SOW tool system 100 further includes the termination of a legal agreement as further described herein with reference to FIG. 9.

FIG. 9 is a key to FIGS. 9A and 9B illustrating a process flow diagram of a method 900 implemented by SOW tool system 100 for terminating an SOW in accordance with one embodiment of the present invention. Although method 900 is described herein with reference to termination of an SOW, the process can also be applied to termination of an EA. In the present embodiment, method 900 is used for terminating SOWs that were originally generated using SOW tool system 100.

Referring to FIGS. 1-9 together, in one embodiment, the engineer can initiate the termination of a SOW. It is assumed that consent of the termination is agreed to by both the company for whom the engineer works and the customer. From an ENTER operation 902, flow moves to a RECEIVE USER INPUT operation 904.

In RECEIVE USER INPUT operation 904, the engineer locates a specific SOW to terminate, for example using Search SOW option 314 of selection panel 304, and inputs selection of Terminate SOW option 316 in selection panel 304, for example, by clicking on Terminate SOW option 316. SOW tool program 106 receives the input of the Terminate SOW option 316. From RECEIVE USER INPUT operation 904, flow moves to a DISPLAY TERMINATE GUI operation 906.

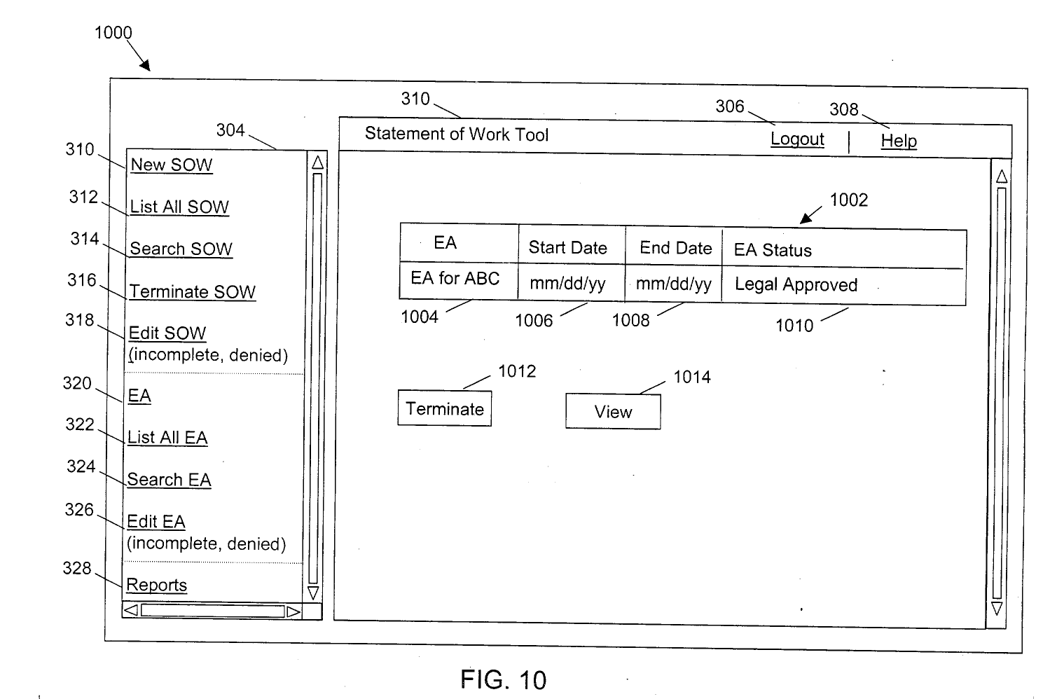

In DISPLAY TERMINATE GUI operation 906, SOW tool program 106 displays a Terminate GUI that includes a brief summary of the selected SOW and an option to terminate the selected SOW. An example of a Terminate GUI is further described herein with reference to FIG. 10.

FIG. 10 illustrates an example of a Terminate GUI 1000 generated by SOW tool system 100 in accordance with one embodiment of the present invention. As illustrated in FIG. 10, in one embodiment, Terminate GUI 1000 includes a brief summary table 1002 of the selected SOW. In one embodiment, brief summary table 1002 includes: a SOW identifier 1004; a start date of the SOW 1006; an end date of the SOW 1008; and, an SOW status 1010. Terminate GUI 100 further includes a Terminate button 1012 and a View button 1014. Selection of Terminate button 1012 inputs selection of the terminate option to SOW tool program 106. Selection of View button 1014 displays a view of the selected SOW. From DISPLAY TERMINATE GUI operation 906, flow moves to a RECEIVE USER INPUT operation 908.

In RECEIVE USER INPUT operation 908, the engineer submits selection of either the terminate button 1012 or the view button 1014. SOW tool program 106 receives the selection. From RECEIVE USER INPUT operation 908, flow moves to a TERMINATE check operation 910.

In TERMINATE check operation 910, SOW tool program 106 determines if the terminate option was input. If the engineer did not select the terminate option, from TERMINATE check operation 910, flow moves to a DISPLAY VIEW operation 912.

In DISPLAY VIEW operation 912, SOW tool program 106 displays a view of the selected SOW on user computer terminal 116. In one embodiment, the view can be the pdf version of the selected SOW stored in internal SOW tool database 108. From DISPLAY VIEW operation 912, flow exits method 900 at an EXIT operation 934 (FIG. 9B).

Returning to TERMINATE check operation 910, if the engineer selects the terminate option, from TERMINATE check operation 910, flow moves to a DISPLAY TERMINATE REASONS GUI operation 914.

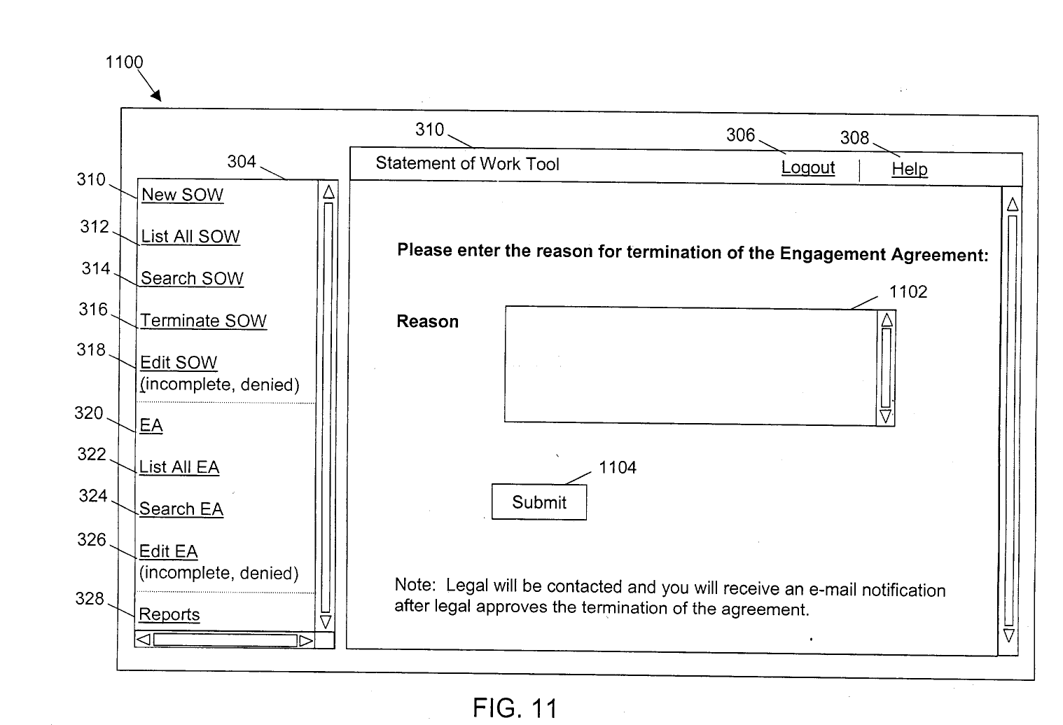

In DISPLAY TERMINATE REASONS GUI operation 914, SOW tool program 106 displays a Terminate Reason GUI on user computer terminal 116. In one embodiment, the Terminate Reasons GUI includes a field for inputting the reasons for the termination of the SOW. An example of a Terminate Reasons GUI is further described herein with reference to FIG. 11.

FIG. 11 illustrates an example of a Terminate Reasons GUI 1100 generated by SOW tool system 100 in accordance with one embodiment of the present invention. As illustrated in FIG. 11, in one embodiment, Terminate Reasons GUI 1100 includes reason field 1002 for entering the reasons for the termination of the SOW. In one embodiment, the engineer submits the reason entered in reason field 1102 by clicking on a submit button 1104. From DISPLAY TERMINATE REASONS GUI operation 914, flow moves to a RECEIVE USER INPUT operation 916.

In RECEIVE USER INPUT operation 916, the engineer inputs the reason for the termination by entering the reason in reason field 1102 and by clicking on submit button 1104. SOW tool program 106 receives the input. From RECEIVE USER INPUT operation 916, flow moves to a GENERATE E-MAIL TO LEGAL operation 918.

In GENERATE E-MAIL TO LEGAL operation 918, SOW tool program 106 generates an e-mail to legal notifying a legal representative that a termination request has been submitted. In one embodiment, the e-mail includes the reason for termination of the SOW and the address on internal network 102 at which the SOW can be viewed. From GENERATE E-MAIL TO LEGAL operation 918, flow moves to an UPDATE STATUS operation 920.

In UPDATE STATUS operation 920, SOW tool program 106 updates the status of the SOW to indicate a termination is in process. For example, a status indicator stored in a status field of internal SOW tool database 108 associated with the SOW is updated to “Termination in process”. From UPDATE STATUS operation 920, flow moves to a DISPLAY CONFIRMATION PAGE operation 922.

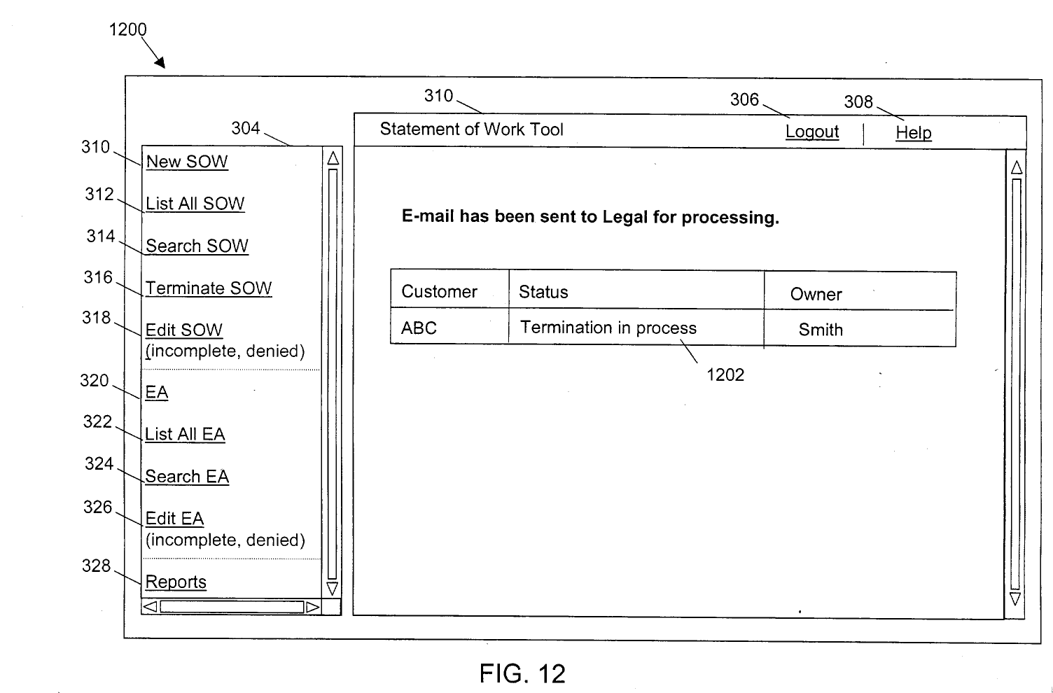

In DISPLAY CONFIRMATION PAGE operation 922, SOW tool program 106 generates and displays a confirmation page on user computer terminal 116. An example of a confirmation page is further described herein with reference to FIG. 12.

FIG. 12 illustrates an example of a Confirmation page 1200 generated by SOW tool system 100 in accordance with one embodiment of the present invention. As illustrated in FIG. 12, in one embodiment, Confirmation page 1200 notifies the engineer that an e-mail has been sent to legal, e.g., a legal representative, and indicates that the termination of the SOW is in process, e.g., status indicator 1202. From DISPLAY CONFIRMATION PAGE operation 922, flow moves to a RECEIVE LEGAL INPUT operation 924.

In RECEIVE LEGAL INPUT operation 924, using legal computer terminal 118, in one embodiment, the legal representative accesses the pdf version of the SOW at the address in the e-mail to legal generated by SOW tool program 106. The legal representative reviews the SOW in light of the reason(s) for termination, for example, by scrolling through the SOW and determines whether to approve or deny the termination.

In one embodiment, at the end of the SOW, the legal representative inputs the determination by selecting an approve option or a deny option, for example, by clicking on an “Approve” or “Deny” button. If the deny option is selected, the legal representative is prompted to input reasons for the denial of the termination. The approve or the deny selection (and reasons for denial) is then received by SOW tool program 106. From RECEIVE LEGAL INPUT operation 924, flow moves to an APPROVE TERMINATION check operation 926.

In APPROVE TERMINATION check operation 926, SOW tool program 106 determines if the termination was approved based on the input received in RECEIVE LEGAL INPUT operation 924. If the termination is not approved, from APPROVE TERMINATION check operation 926, flow moves to a GENERATE E-MAIL TO USER operation 928.

In GENERATE E-MAIL TO USER operation 928, an e-mail is generated to the engineer advising of the denial of the termination request. From GENERATE E-MAIL TO USER operation 928, flow exits method 900 at an EXIT operation 934.

Returning to APPROVE TERMINATION check operation 926, if the termination is approved, from APPROVE 35 TERMINATION check operation 926, flow moves to a GENERATE E-MAIL TO USER operation 930.

In GENERATE E-MAIL TO USER operation 930, an e-mail is generated to the engineer advising of the approval of the termination request. From GENERATE E-MAIL TO USER operation 930, flow moves to an UPDATE STATUS operation 932.

In UPDATE STATUS operation 932, SOW tool program 106 updates the status of the SOW to indicate termination. For example, a status indicator stored in a status field of internal SOW tool database 108 associated with the SOW is updated to “Terminated”. From UPDATE STATUS operation 932, flow exits method 900 at EXIT operation 934.

As earlier described with reference to main menu GUI 300, selection panel 304 includes several options that aid in the management of project development resources including List All SOW option 312, Search SOW option 314, List All EA option 322, Search EA option 324, and Reports option 328.

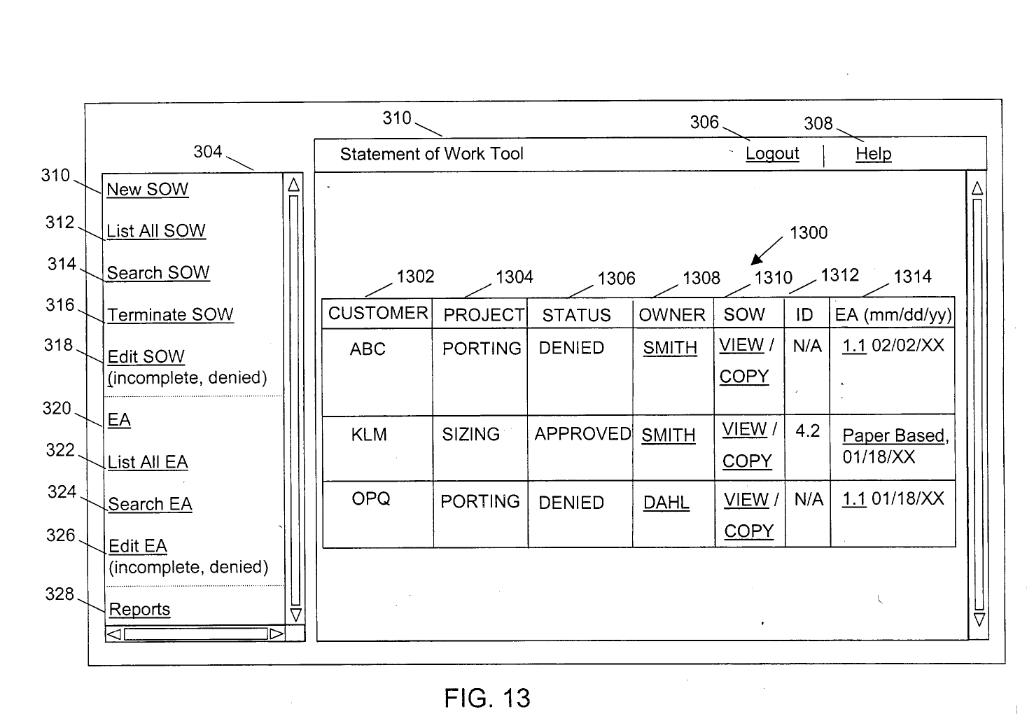

Selection of List All SOW option 312 via user computer terminal 116, for example, by the engineer clicking on List All SOW option 312, results in input of the selection to SOW tool program 106. In response, SOW tool program 106 generates a list of all SOWs present in internal SOW tool database 108 and displays the list on user computer terminal 116. An example of a list displayed in response to selection of List All SOW option 312 is further described herein with reference to FIG. 13.

FIG. 13 illustrates an example of a list 1300 generated by SOW tool system 100 in response to selection of List All SOW option 312 in accordance with one embodiment of the present invention. As illustrated in FIG. 13, in one embodiment, list 1300 includes all SOWs located by SOW tool program 106 in internal SOW tool database 108. In the present embodiment, list 1300 is presented in table format, however, other formats can also be used. In one embodiment, list 1300 includes data for: a customer (name) 1302; a project (identifier) 1304; a status 1306; an owner (name) 1308; a SOW selector 1310; an ID (identifier) 1312; and an EA (version identifier) 1314.

In the present embodiment, selectable view and copy options are provided for each SOW in an associated SOW selector 1310. In one embodiment, selection of the view option results in display of an html version of the SOW. However, in other embodiments, the pdf version, or other viewable version, of the SOW can be displayed. In one embodiment, selection of the copy option tags the SOW and copies the SOW data into a new SOW display permitting the engineer to generate a new SOW without having to re-enter data present in a particular SOW.

As illustrated, EA (version identifier) 1314 lists the EA version associated with a particular SOW. In one embodiment, selection of a particular EA (version identifier) 1314 associated with a particular SOW results in display of the EA, for example, display of the pdf version of the particular EA.

In one embodiment, an owner name 1308 associated with a particular SOW is selectable, for example, by clicking on SMITH, and selection results in the automatic generation of an e-mail window addressed to the owner name, e.g., SMITH, permitting the engineer to input and send an e-mail to the owner. In the present embodiment, it can be appreciated by those of skill in the art that some fields may be not applicable (N/A) or left empty dependent on the status of the SOW and or EA.

Selection of Search SOW option 314 via user computer terminal 116, for example, by the engineer clicking on Search SOW option 314, results in input of the selection to SOW tool program 106. In response, SOW tool program 106 generates a Search SOW GUI on user computer terminal 116. In one embodiment, the Search SOW GUI includes fields that permit the engineer to specify and submit search parameters to SOW tool program 106.

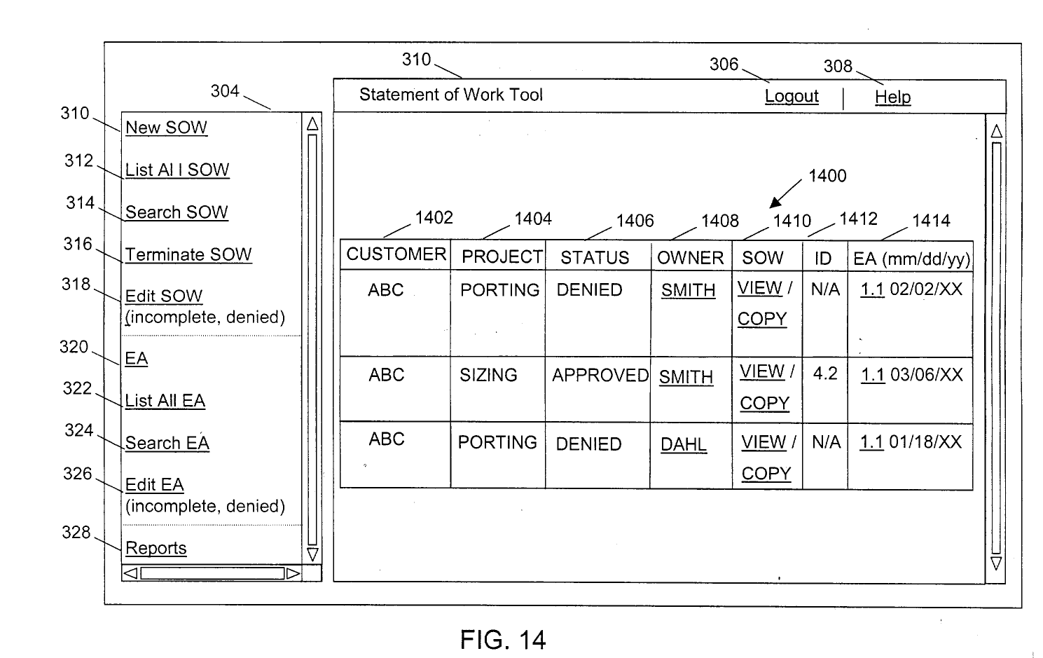

In response to submission of the search parameters, SOW tool program 106 searches internal SOW tool database 108 for SOWs meeting the specified search parameters. SOW tool program 106 generates a list of all SOWs that meet the specified search parameters and displays the list on user computer terminal 116. Database search processes and input of search parameters to a search process are well known to those of skill in the art and are not further described herein to avoid detracting from the description of the present invention. An example of a list displayed in response to selection of Search SOW option 314 and submission of search parameters on a Search SOW GUI is further described herein with reference to FIG. 14.

FIG. 14 illustrates an example of a list 1400 generated by SOW tool system 100 in response to selection of Search SOW option 314 and submission of specified search parameters to a Search SOW GUI in accordance with one embodiment of the present invention. As illustrated in FIG. 14, in one embodiment, list 1400 includes all. SOWs located by SOW tool program 106 in internal SOW tool database 108 meeting the specified search parameters, for example, such as SOWs for customer ABC. In one embodiment, presentation of list 1400 is in table format, however, other formats can also be used. In one embodiment, list 1400 includes data for: a customer (name) 1402; a project (identifier) 1404; a status 1406; an owner (name) 1408; a SOW selector 1410; an ID (identifier) 1412; and an EA (version identifier) 1414.

In the present embodiment, selectable view and copy options are provided for each SOW in an associated SOW selector 1410. In one embodiment, selection of the view option results in display of an html version of the SOW. However, in other embodiments, the pdf version, or other viewable version, of the SOW can be displayed. In one embodiment, selection of the copy option tags the SOW and copies the SOW data into a new SOW display permitting the engineer to generate a new SOW without having to re-enter data present in a particular SOW.

As illustrated, EA (version identifier) 1414 lists the EA version associated with a particular SOW. In one embodiment, selection of a particular EA (version identifier) 1414 associated with a particular SOW results in display of the EA, for example, display of the pdf version of the particular EA.

In one embodiment, an owner name 1408 associated with a particular SOW is selectable, for example, by clicking on DAHL, and selection of a particular owner name 1408 results in the automatic generation of an e-mail window addressed to the owner name, e.g., DAHL, permitting the engineer to input and send an e-mail to the owner. In the present embodiment, it can be appreciated by those of skill in the art that some fields may be not applicable (N/A) or left empty dependent on the status of the SOW and or EA.

Additionally, it an be appreciated by those of skill in the art, list 1400 is but an exemplary list as a particular list and data included in that list varies dependent upon the requested search parameters, for example, such as particular customer name or a particular status.

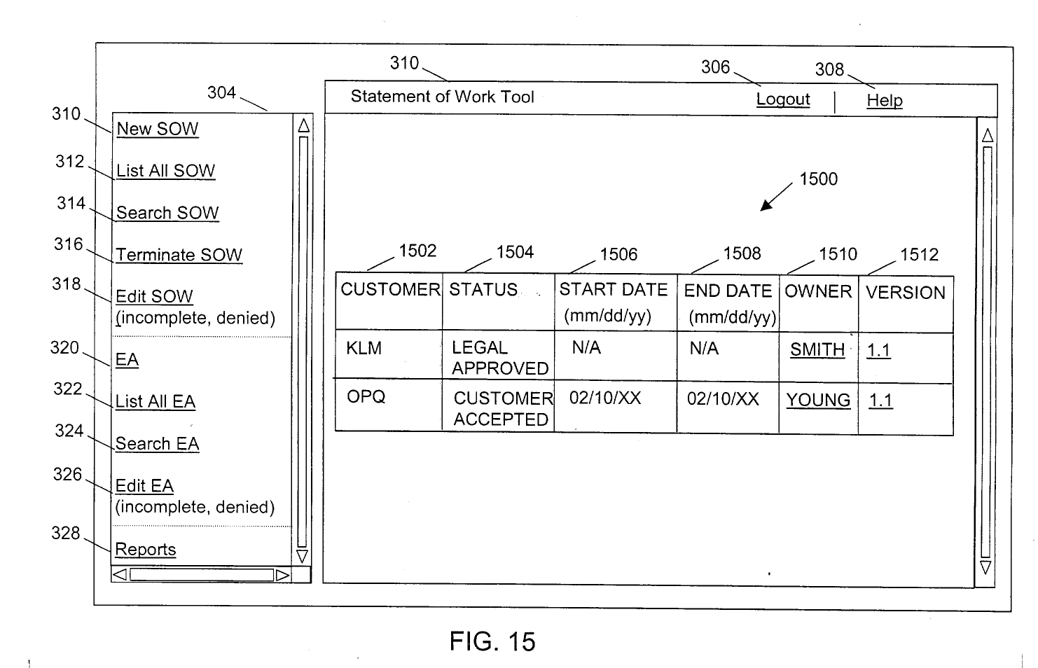

Selection of List All EA option 322 via user computer terminal 116, for example, by the engineer clicking on List All EA option 322, results in input of the selection to SOW tool program 106. In response, SOW tool program 106 generates a list of all EAs present in internal SOW tool database 108 and displays the list on user computer terminal 116. An example of a list displayed in response to selection of List All EA option 322 is further described herein with reference to FIG. 15.

FIG. 15 illustrates an example of a list 1500 generated by SOW tool system 100 in response to selection of List All EA option 322 in accordance with one embodiment of the present invention. As illustrated in FIG. 15, in one embodiment, list 1500 includes all EAs located by SOW tool program 106 in internal SOW tool database 108. In the present embodiment, list 1500 is presented in table format; however, other formats can also be used. In one embodiment, list 1500 includes data for: a customer (name) 1502; a status 1504; a start date 1506; and end date 1508; an owner (name) 1510; and a version (identifier) 1512.

In the present embodiment, selection of a particular version (identifier) 1512 associated with an EA, such as by clicking on 1.1 associated with customer KLM, results in display of the EA. In one embodiment, a pdf version of the EA is displayed. However, in other embodiments, an html version, or other viewable version, of the EA can be displayed.

In one embodiment, a particular owner name 1510 is selectable, for example, by clicking on YOUNG, and selection results in the automatic generation of an e-mail window addressed to the owner name, e.g., YOUNG, permitting the engineer to input and send an e-mail to the owner. In the present embodiment, it can be appreciated by those of skill in the art that some fields may be not applicable (N/A) or left empty dependent on the status of the EA.

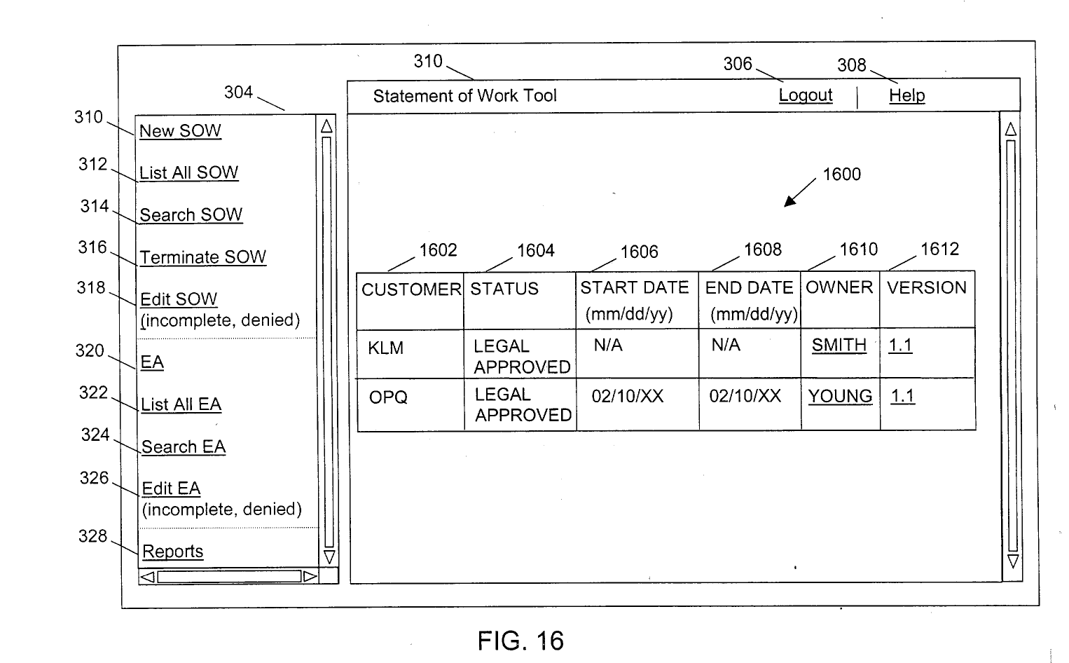

Selection of Search EA option 324 via user computer terminal 116, for example, by the engineer clicking on Search EA option 324, results in input of the selection to SOW tool program 106. In response, SOW tool program 106 displays a Search EA GUI on user computer terminal 116. In one embodiment, the Search EA GUI includes fields that permit the engineer to specify and submit EA search parameters to SOW tool program 106. In response, SOW tool program 106 searches internal SOW tool database 108 for EAs meeting the specified search parameters. SOW tool program 106 generates a list of all EAs meeting the specified search parameters and displays the list on user computer terminal 116. An example of a list displayed in response to selection of Search EA option 324 and submission of search parameters to the Search EA GUI is further described herein with reference to FIG. 16.

FIG. 16 illustrates an example of a list 1600 generated by SOW tool system 100 in response to selection of Search EA option 324 and submission of search parameters to a Search EA GUI in accordance with one embodiment of the present invention. As illustrated in FIG. 16, in one embodiment, list 1600 includes all. EAs located by SOW tool program 106 in internal SOW tool database 108 meeting the specified search parameters for example, such as EAs approved by legal. In one embodiment, presentation of list 1600 is in table format; however, other formats can also be used. In one embodiment, list 1600 includes data for: a customer (name) 1602; a status 1604; a start date 1606; and end date 1608; an owner (name) 1610; and a version (identifier) 1612.

In the present embodiment, selection of a particular version (identifier) 1612 associated with an EA, such as by clicking on 1.1 associated with customer OPQ, results in display of the EA. In one embodiment, a pdf version of the EA is displayed. However, in other embodiments, an html version, or other viewable version, of the EA can be displayed.

In one embodiment, a particular owner name 1610 is selectable, for example, by clicking on SMITH, and selection results in the automatic generation of an e-mail window addressed to the owner name, e.g., SMITH, permitting the engineer to input and send an e-mail to the owner. In the present embodiment, it can be appreciated by those of skill in the art that some fields may be not applicable (N/A) or left empty dependent on the status of the EA.

As can be appreciated by those of skill in the art, list 1600 is but an exemplary list as a particular list and data included in that list varies dependent upon the requested search parameters, such as customer name or status.

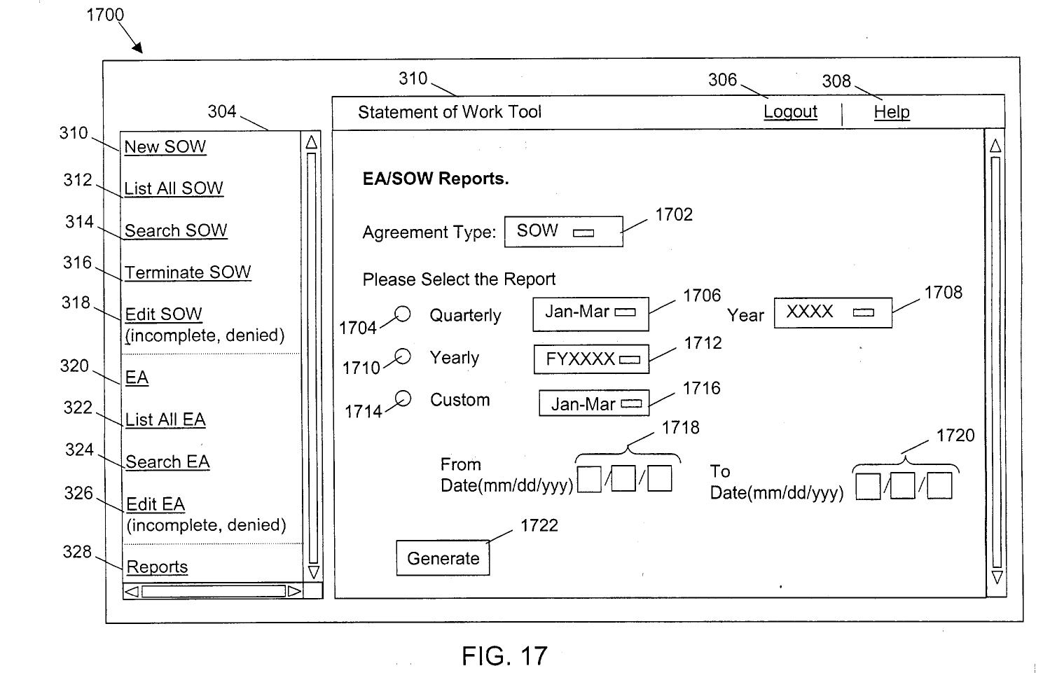

Selection of Reports option 328 via user computer terminal 116, for example, by the engineer clicking on Reports option 328, results in input of the selection to SOW tool program 106. In response, SOW tool program 106 displays a Reports GUI on user computer terminal 116. In one embodiment, the Reports. GUI includes fields that permit the engineer to specify and submit report parameters to SOW tool program 106. An example of a Reports GUI displayed in response to selection of Reports option 328 is further described herein with reference to FIG. 17.

FIG. 17 illustrates an example of a Reports GUI 1700 generated by SOW tool system 100 in response to selection of Reports option 324 in accordance with one embodiment of the present invention. As illustrated in FIG. 17, in one embodiment, Reports GUI 1700 includes various fields the permit the engineer to specify search parameters for use by SOW tool program 106 in generating a report. In one embodiment, Reports GUI 1700 includes: an agreement type pull-down menu 1702; a quarterly report option 1704; a yearly report option 1710; and a custom report option 1714.

If quarterly report option 1704 is selected pull-down menu 1706 permits selection of a specific quarter, and pull-down menu 1708 permits selection of a specific year. If yearly report option 1710 is selected, pull-down menu 1712 permits selection of a specific year. In one embodiment, the year is a fiscal year. While in other embodiments, the year can be a calendar year. If custom report option 1714 is selected, pull-down menu 1716 permits selection of a specific-quarter or other specific time frames utilizing from date fields 1718 and to date fields 1720. The report parameters are input to SOW tool program 106, for example, by clicking on a generate button 1722.

In response, SOW tool program 106 searches internal SOW tool database 108 for SOWs and/or EAs meeting the specified report parameters. SOW tool program 106 generates a list of all SOWs and/or EAs that meet the specified search parameters and displays the list in a Report on user computer terminal 116.

In some embodiments, SOW tool system 100 automatically stores the start date and expiration dates of legal agreements in internal SOW tool database 108, and automatically generates and sends an e-mail to the engineer and/or engineer's manager advising that a specified legal agreement is to expire. In one embodiment, SOW tool system 100 automatically generates and sends the e-mail sixty days prior to the expiration date.

As earlier described with reference to FIGS. 2 and 8, in one embodiment, a No EA GUI is displayed on user computer terminal 116 notifying the engineer that an EA does not exist for the customer in internal SOW tool database 108 and providing the engineer a selectable option to create an EA. In one embodiment, the No EA GUI includes a standard EA option and a paper-based option. The standard EA option permits the engineer to generate a new EA utilizing SOW tool system 100 as earlier described with reference to method 800 and FIG. 8. The paper-based option permits the engineer to input data from an existing paper-based EA. An example of a No EA GUI including both a create a standard EA option and an add paper-based EA option is further described herein with reference to FIG. 18.

FIG. 18 illustrates an example of a No EA GUI 1800 generated by SOW tool system 100 in accordance with one embodiment of the present invention. In one embodiment, No EA GUI 1800 includes a standard EA option 1802 and a paper-based option 1804. Standard EA option 1802 permits the engineer to generate a new EA utilizing SOW tool system 100. Paper-based option 1804 permits the engineer to input data from an existing paper-based EA. Submission of standard EA option 1802 or paper-based EA option 1804 to SOW tool program 106 is made by clicking on a continue button 1806. In response to selection of standard EA option 1802, the engineer enters method 800 earlier described with reference to FIG. 8.

In one embodiment, selection of paper-based option 1804 results in display of an Input Paper-based EA GUI including fields where the engineer inputs the information from a paper-based EA for submission SOW tool program 106 and internal SOW tool database 108. In one embodiment the paper-based EA does not go through the approval process earlier outlined with reference to method 800 and FIG. 8. In one embodiment, SOW tool system 100 displays paper-based EAs differently from EAs generated using SOW tool system 100. For example, in one embodiment, paper-based EAs are displayed in red.

As earlier described with reference to FIG. 7, method 700 can be entered by selection of Edit SOW option 318. Selection of Edit SOW option 318 via user computer terminal 116, for example, by the engineer clicking on Edit SOW option 318, results in input of the selection to SOW tool program 106. In one embodiment, selection of Edit SOW option 318 results in display of a list including all SOW(s) in internal SOW tool database available for editing or deleting. An example of a list generated by SOW tool system 100 in response to selection of Edit SOW option 318 is further described herein with reference to FIG. 19.

FIG. 19 illustrates an example of a list 1900 generated by SOW tool system 100 in response to selection of Edit SOW option 318 in accordance with one embodiment of the present invention. As illustrated in FIG. 19, in one embodiment, list 1900 includes all SOWs located by SOW tool program 106 in internal SOW tool database 108 that are available for editing or deletion, for example, such as incomplete, denied or non-accepted SOWs. In one embodiment, presentation of list 1900 is in table format, however, other formats can also be used. In one embodiment, list 1900 includes data for: a customer (name) 1902; a project (identifier) 1904; a status 1906; and an SOW selector 1908.

In the present embodiment, selectable edit and delete options are provided for each SOW in an associated SOW selector 1908. In one embodiment, selection of the edit option results in display of an editable html version of the SOW. However, in other embodiments, a different editable version of the SOW can be displayed. This permits an engineer to edit the SOW as earlier described with reference to method 700 and FIG. 7. In one embodiment, selection of the delete option permits the engineer to delete the particular Sow.

As earlier described, SOW tool system 100 also permits editing of EAs (see method 800 and FIG. 8) and method 700 is also applicable to editing of an EA. In one embodiment, method 700 can be entered for editing an EA by selection of Edit EA option 326. For example, the engineer can select Edit EA option 326 in selection panel 304. In one embodiment, selection of Edit EA option 326 results in display of a list including all EA(s) in internal SOW tool database 108 available for editing or deleting.

In one embodiment, the list of EA(s) available for editing or deleting includes, similar to list 1900 (FIG. 19), the name of the customer, the project, the status, and edit/delete options for each listed EA—such as within an EA selector column, rather than SOW selector 1908. In one embodiment, selection of an edit option next to a particular EA, inputs selection of method 700 for that particular EA to SOW tool program 106. Selection of a delete option, deletes the EA.

As described above, and unlike the prior art, the present invention includes an automated SOW tool system 100 that improves the process of generating and terminating legal agreements within a project development process, and generates lists and reports to aid in more efficiently managing project development resources. Further, the present invention interfaces the customer in the generation of the legal agreement via an external network, such as the Internet, to maintain the integrity of an internal company network that may be protected by a firewall or other protective device.

As earlier described with reference to FIG. 1, SOW tool program 106 can be configured as a computer program product. Herein a computer program product comprises a medium configured to store or transport computer-readable instructions, such as program code for SOW tool program 106, including all, any, or parts of methods 200, 700, 800, and 900, or in which computer-readable instructions for SOW tool program 106, including all, any, or parts of methods 200, 700, 800, and 900, is stored. Some examples of computer program products are CD-ROM discs, ROM cards, floppy discs, magnetic tapes, computer hard drives, servers on a network and signals transmitted over a network representing computer-readable instructions. Further herein, a means for performing a particular function is accomplished using the-appropriate computer-readable instructions and the related hardware necessary to performing the function.

The foregoing description of implementations of the invention have been presented for purposes of illustration and description only, and, therefore, are not exhaustive and do not limit the invention to the precise forms disclosed.

Modifications and variations are possible in light of the above teachings or can be acquired from practicing the invention. Consequently, Applicants do not wish to be limited to the specific embodiments shown for illustrative purposes.

What is claimed is:

1. A Statement of Work (SOW) tool system comprising:
an SOW tool program;
a first computer terminal communicatively coupled to the SOW tool program;
a second computer terminal communicatively coupled to the SOW tool program;
an internal SOW tool database communicatively coupled to the SOW tool program;
an external SOW tool database communicatively coupled to the SOW tool program; and
a third computer terminal communicatively coupled to the external SOW tool database.

2. The SOW tool system of claim 1, wherein the SOW tool program, the first computer terminal, the second computer terminal, and the internal SOW tool database are part of an internal network.

3. The SOW tool system of claim 2, wherein the external SOW tool database and the third computer terminal are part of an external network.

4. The SOW tool system of claim 3, wherein the external network is the Internet.

5. The SOW tool system of claim 1, further comprising:
a PE tool program communicatively coupled to the SOW tool program, the PE tool program further comprising a PE tool database.

6. The SOW tool system of claim 2, further comprising:
a directory database communicatively coupled to the SOW tool program.

7. A method for generating a legal agreement, the method comprising:
providing an internal network;
communicatively coupling a first party to the internal network;
communicatively coupling a second party to the internal network;
providing a program for generating a legal agreement, the program being accessible on the internal network;
inputting legal agreement data into the program by the first party;
the program generating a legal agreement;
the program posting the legal agreement to the internal network for viewing and action by the second party, wherein the second party accesses the legal agreement and inputs an approval or a denial of the legal agreement to the program thereby creating an approved or denied legal agreement;
providing an external network separate from the internal network;
the program posting the approved legal agreement to the external network for viewing and action by a third party; and
communicatively coupling the third party to the external network for viewing the approved legal agreement, wherein the third party accesses the approved legal agreement and inputs an acceptance or a non-acceptance of the approved legal agreement thereby creating an accepted or a non-accepted legal agreement.

8. The method of claim 7, wherein the method further comprises:
providing an internal database on the internal network, wherein the internal database is coupled to the program, further wherein the posting the legal agreement to the internal network for viewing and action by the second party is to the internal database; and
providing an external database on the external network, wherein the external database is accessible on the external network, further wherein the posting the approved legal agreement to the external network for viewing and action by a third party is to the external database; and
automatically logging the acceptance or the non-acceptance of the approved legal agreement on the external database thereby creating logged data.

9. The method of claim 8, wherein the program stores a status indicator associated with the legal agreement on the internal database, wherein the status indicator indicates the status of the legal agreement.

10. The method of claim 9, further comprising:
when the second party inputs the approval or the denial of the legal agreement, the program updating the status indicator associated with the legal agreement to indicate the legal agreement is approved or denied.

11. The method of claim 9, further comprising:
updating the internal database with at least a portion of the logged data.

12. The method of claim 11, further comprising:
when the program updates the internal database with at least a portion of the logged data, the program updating the status indicator associated with the legal agreement to indicate the legal agreement is accepted or not accepted.

13. The method of claim 7, wherein the first party is a user, the second party is a legal department, and wherein the third party is a customer of the user.

14. The method of claim 7, wherein the program is further for generating reports including at least a portion of the data stored in the internal database associated with the legal agreement.

15. The method of claim 7, wherein the program is further for terminating legal agreements.

16. The method of claim 7, wherein the program is an SOW tool program.

17. A method for generating a legal agreement, the method comprising:
providing an internal network;
providing an SOW tool program for generating a legal agreement on the internal network;
providing an internal database on the internal network, wherein the internal database is coupled to the SOW tool program, the SOW tool program storing data related to the legal agreement in the internal database;
communicatively coupling a first party to the internal network;
communicatively coupling a second party to the internal network;
inputting legal agreement data into the SOW tool program by the first party;
the SOW tool program generating a legal agreement;
the SOW tool program posting the legal agreement to the internal network for viewing and action by the second party, wherein the second party accesses the legal agreement and inputs an approval or a denial of the legal agreement to the SOW tool program thereby creating an approved or denied legal agreement;
providing an external network separate from the internal network;
providing an external database on the external network, wherein the external database is accessible on the external network;
the SOW tool program posting the approved legal agreement to the external network for viewing and action by a third party;
communicatively coupling the third party to the external network for viewing the approved legal document, wherein the third party accesses the approved legal agreement and inputs an acceptance or a non-acceptance of the approved legal agreement to the external database thereby creating an accepted or a non-accepted legal agreement;
automatically logging the acceptance or the non-acceptance of the approved legal agreement on the external database thereby creating logged data; and
updating the internal database with at least a portion of the logged data.

18. The method of claim 17, wherein the program stores a status indicator associated with the legal agreement on the internal database, wherein the status indicator indicates the status of the legal agreement.

19. A computer system comprising:
a processor; and
a memory coupled to the processor, and having stored therein computer readable instructions for a method for generating a legal agreement, wherein upon execution of the computer readable instructions on the processor, the method comprises:
receiving input of legal agreement data from a first party communicatively coupled to an internal network;
generating a legal agreement;
posting the legal agreement to an internal database on the internal network for viewing and action by a second party communicatively coupled to the internal network, wherein the second party accesses the legal agreement on the internal database and inputs an approval or a denial of the legal agreement thereby creating an approved or denied legal agreement;
receiving input of the approval or the denial of the legal agreement;
posting the approved legal agreement to an external database on an external network for viewing and action by a third party communicatively coupled to the external network, wherein the third party accesses the approved legal agreement and inputs an acceptance or a non-acceptance of the approved legal agreement to the external database thereby creating an accepted or a non-accepted legal agreement;
receiving input of the acceptance or the non-acceptance of the approved legal agreement;
automatically logging the acceptance or the non-acceptance of the approved legal agreement on the external database thereby creating logged data; and
updating the internal database with at least a portion of the logged data.

20. A computer program product for generating a legal agreement, the computer program product comprising computer-readable instructions for a method comprising:
receiving input of legal agreement data from a first party communicatively coupled to an internal network;
generating a legal agreement;
posting the legal agreement to an internal database on the internal network for viewing and action by a second party communicatively coupled to the internal network, wherein the second party accesses the legal agreement on the internal database and inputs an approval or a denial of the legal agreement thereby creating an approved or denied legal agreement;
receiving input of the approval or the denial of the legal agreement;
posting the approved legal agreement to an external database on an external network for viewing and action by a third party communicatively coupled to the external network, wherein the third party accesses the approved legal agreement and inputs an acceptance or a non-acceptance of the approved legal agreement to the external database thereby creating an accepted or a non-accepted legal agreement;
receiving input of the acceptance or the non-acceptance of the approved legal agreement;
automatically logging the acceptance or the non-acceptance of the approved legal agreement on the external database thereby creating logged data; and
updating the internal database with at least a portion of the logged data.
